(19) United States
(12) Patent Application Publication
(10) Pub. No.: US 2020/0249510 A1
(43) Pub. Date: Aug. 6, 2020

(54) ARRAY SUBSTRATE, DISPLAY PANEL, AND DISPLAY DEVICE

(71) Applicant: Sharp Kabushiki Kaisha, Sakai City (JP)

(72) Inventors: YOSHIHIRO ASAI, Sakai City (JP); SATOSHI HORIUCHI, Sakai City (JP); SEIJIROU GYOUTEN, Sakai City (JP)

(21) Appl. No.: 16/776,057

(22) Filed: Jan. 29, 2020

Related U.S. Application Data
(60) Provisional application No. 62/800,447, filed on Feb. 2, 2019.

(51) Int. Cl. G02F 1/1368; G02F 1/1339; G02F 1/1337; G02F 1/1333; G02F 1/1345

(52) U.S. Cl. CPC G02F 1/1368; G02F 1/1339; G02F 2001/133357; G02F 1/133345; G02F 1/13454; G02F 1/1337

(57) ABSTRACT

An array substrate includes an insulating substrate, a source metal film disposed in a layer upper than the insulating substrate, a first insulating film disposed on the source metal film, and an alignment film disposed on the first insulating film. The first insulating film includes a groove portion including a through portion and a recess portion. The through portion extends through the first insulating film and the recess portion is recessed in the first insulating film so as not to extend through the first insulating film. The through portion does not overlap the source metal film and the recess portion overlaps at least the source metal film.

### CROSS REFERENCE TO RELATED APPLICATION

This application claims priority from U.S. Provisional Patent Application No. 62/800,447 filed on Feb. 2, 2019. The entire contents of the priority application are incorporated herein by reference.

### TECHNICAL FIELD

The technology described herein relates to an array substrate, a display panel, and a display device.

### BACKGROUND ART

A liquid crystal panel, which is a main component of a liquid crystal display device, includes a pair of substrates and a liquid crystal layer that is sealed between the substrates, and further includes an alignment film on an inner plate surface of the substrates. The alignment film is made of an organic insulating material such as polyimide resin and for aligning liquid crystal molecules included in the liquid crystal layer. The alignment film is generally disposed on an entire area of a plate surface of a substrate except for an outer peripheral portion thereof by applying droplets thereon. The alignment film material having low viscosity and high fluidity is used such that droplets of the alignment film material are spread smoothly without causing thickness unevenness.

In a configuration using the alignment film material having high fluidity, if the alignment film material is spread to the outer peripheral portion of the substrate, a problem may be caused. A sealant for sealing the liquid crystal layer and a driver IC for supplying driving signals to the liquid crystal panel are arranged on the outer peripheral portion of the substrate after forming the alignment film. If the alignment film material is disposed on portions where such components are to be arranged, a sealing property of the sealant may be degraded or connection errors are likely to be caused in the driver IC. Therefore, it has been known to dispose a restricting portion that restricts spread of the alignment film material on the outer peripheral portion of the substrate. One example of such a restricting portion is described in WO/2015/045581. The restricting portion is provided by recessing a portion of a surface of the organic insulating film (a planarizing film) that is included in a layer lower than the alignment film. If the droplets of the alignment film material are supplied onto the surface of the planarizing film, the alignment film material that reaches the outer peripheral portion is stored in the restricting portion. Thus, the alignment film material is less likely to be spread.

However, the restricting portion may not have a sufficient storing capacity (a restricting amount) depending on a depth of the recess and the alignment film material may be spread and flow over the restricting portion. If the restricting portion is formed to extend through the planarizing film to have a greater depth and increase the restricting amount, the inorganic insulating film (a protection film) that is disposed in a layer lower than the planarzigin film is also removed with etching by using the same mask in the producing process. If the protection film is removed, the source metal film that is disposed in a layer lower than the protection film and includes portions as the source lines is contacted with the alignment film material, and the characteristics of the source metal film may be deteriorated by moisture contained in the alignment film material.

Further, to avoid such a problem, an area of the outer peripheral portion (a non-display area) of the substrate may be increased to separately provide an area where no source metal film is disposed below the protection film and a deep restricting portion may be provided in the area. However, this increases a frame width of the liquid crystal display device.

### SUMMARY

The technology described herein was made in view of the above circumstances. An object is to surely restrict spread of an alignment film material while preventing deterioration of a metal film.

An array substrate according to the technology described herein includes an insulating substrate, a source metal film disposed in a layer upper than the insulating substrate, a first insulating film disposed on the source metal film, and an alignment film disposed on the first insulating film. The first insulating film includes a groove portion including a through portion and a recess portion. The through portion extends through the first insulating film and the recess portion is recessed in the first insulating film so as not to extend through the first insulating film. The through portion does not overlap the source metal film and the recess portion overlaps at least the source metal film.

A display panel according to the technology described herein includes the array substrate and an opposed substrate opposed to the array substrate so as to have an inner space therebetween.

A display device according to the technology described herein includes the display panel.

According to the technology described herein, spread of an alignment film material is surely restricted while preventing deterioration of a metal film.

### BRIEF DESCRIPTION OF THE DRAWINGS

FIG. 1 is a plan view of a liquid crystal display device according to a first embodiment.

FIG. 2 is a cross-sectional view taken along line II-II in FIG. 1.

FIG. 3 is a plan view illustrating a wiring structure on an array substrate.

FIG. 4 is an enlarged view of a frame section IV in

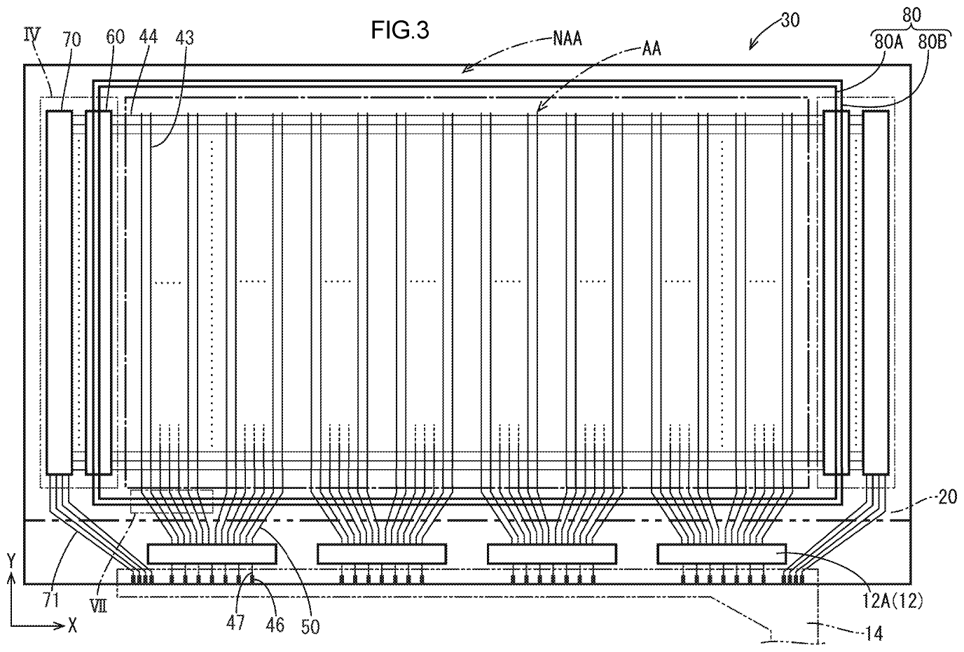

FIG. 3.

FIG. 5 is a plan view illustrating a recess portion formed in a gate line driving circuit (GDM).

FIG. 6A is a cross-sectional view taken along line A-A in FIG. 5.

FIG. 6B is a cross-sectional view taken along line B-B in FIG. 5.

FIG. 6C is a cross-sectional view taken along line C-C in FIG. 5.

FIG. 7 is an enlarged view of a frame section VII in FIG. 3.

FIG. 8 is a cross-sectional view taken along line A-A in FIG. 7.

FIG. 9A is a cross-sectional view illustrating a forming process of forming the recess portion described in FIG. 6A.

FIG. 9B is a cross-sectional view illustrating a forming process of forming the recess portion described in FIG. 6A.

FIG. 9C is a cross-sectional view illustrating a forming process of forming the recess portion described in FIG. 6A.

FIG. 9D is a cross-sectional view illustrating a forming process of forming the recess portion described in FIG. 6A.

FIG. 9E is a cross-sectional view illustrating a forming process of forming the recess portion described in FIG. 6A.

FIG. 9F is a cross-sectional view illustrating a forming process of forming the recess portion described in FIG. 6A.

FIG. 9G is a cross-sectional view illustrating a forming process of forming the recess portion described in FIG. 6A.

FIG. 9H is a cross-sectional view illustrating a forming process of forming the recess portion described in FIG. 6A.

FIG. 10A is a cross-sectional view illustrating a forming process of forming the recess portion described in FIG. 6B.

FIG. 10B is a cross-sectional view illustrating a forming process of forming the recess portion described in FIG. 6B.

FIG. 10C is a cross-sectional view illustrating a forming process of forming the recess portion described in FIG. 6B.

FIG. 10D is a cross-sectional view illustrating a forming process of forming the recess portion described in FIG. 6B.

FIG. 10E is a cross-sectional view illustrating a forming process of forming the recess portion described in FIG. 6B.

FIG. 10F is a cross-sectional view illustrating a forming process of forming the recess portion described in FIG. 6B.

FIG. 10G is a cross-sectional view illustrating a forming process of forming the recess portion described in FIG. 6B.

FIG. 10H is a cross-sectional view illustrating a forming process of forming the recess portion described in FIG. 6B.

FIG. 11A is a cross-sectional view illustrating a forming process of forming the recess portion described in FIG. 6C.

FIG. 11B is a cross-sectional view illustrating a forming process of forming the recess portion described in FIG. 6C.

FIG. 11C is a cross-sectional view illustrating a forming process of forming the recess portion described in FIG. 6C.

FIG. 11D is a cross-sectional view illustrating a forming process of forming the recess portion described in FIG. 6C.

FIG. 11E is a cross-sectional view illustrating a forming process of forming the recess portion described in FIG. 6C.

FIG. 11F is a cross-sectional view illustrating a forming process of forming the recess portion described in FIG. 6C.

FIG. 11G is a cross-sectional view illustrating a forming process of forming the recess portion described in FIG. 6C.

FIG. 11H is a cross-sectional view illustrating a forming process of forming the recess portion described in FIG. 6C.

FIG. 12 is a plan view illustrating a groove portion according to a second embodiment.

FIG. 13 is a cross-sectional view taken along line A-A in FIG. 12.

FIG. 14 is a plan view illustrating a groove portion according to a third embodiment.

FIG. 15 is a cross-sectional view taken along line A-A in FIG. 14.

FIG. 16 is a plan view illustrating a groove portion according to a fourth embodiment.

FIG. 17 is a cross-sectional view taken along line A-A in FIG. 16.

FIG. 18 is a plan view illustrating a groove portion according to a fifth embodiment.

FIG. 19 is a cross-sectional view taken along line A-A in FIG. 18.

FIG. 20 is a plan view illustrating a groove portion according to a sixth embodiment.

FIG. 21A is a cross-sectional view taken along line A-A in FIG. 20.

FIG. 21B is a cross-sectional view taken along line B-B in FIG. 20.

FIG. 22A is a cross-sectional view illustrating a groove portion according to a seventh embodiment taken along line A-A in FIG. 5.

FIG. 22B is a cross-sectional view illustrating the groove portion according to the seventh embodiment taken along line B-B in FIG. 5.

FIG. 22C is a cross-sectional view illustrating the groove portion according to the seventh embodiment taken along line B-B in FIG. 5.

FIG. 23 is a cross-sectional view illustrating a groove portion according to a first modification taken along line A-A in FIG. 20.

FIG. 24A is a cross-sectional view illustrating a forming process of forming a recess portion described in FIG. 21A.

FIG. 24B is a cross-sectional view illustrating a forming process of forming the recess portion described in FIG. 21A.

FIG. 24C is a cross-sectional view illustrating a forming process of forming the recess portion described in FIG. 21A.

FIG. 24D is a cross-sectional view illustrating a forming process of forming the recess portion described in FIG. 21A.

FIG. 24E is a cross-sectional view illustrating a forming process of forming the recess portion described in FIG. 21A.

FIG. 24F is a cross-sectional view illustrating a forming process of forming the recess portion described in FIG. 21A.

FIG. 24G is a cross-sectional view illustrating a forming process of forming the recess portion described in FIG. 21A.

FIG. 24H is a cross-sectional view illustrating a forming process of forming the recess portion described in FIG. 21A.

FIG. 25 is a cross-sectional view illustrating a groove portion according to a second modification taken along line A-A in FIG. 12.

FIG. 26 is a cross-sectional view illustrating a groove portion according to a third modification taken along line A-A in FIG. 7.

FIG. 27 is a plan view illustrating a groove portion according to a fourth modification.

FIG. 28 is a cross-sectional view taken along line A-A in FIG. 27.

### DETAILED DESCRIPTION

### First Embodiment

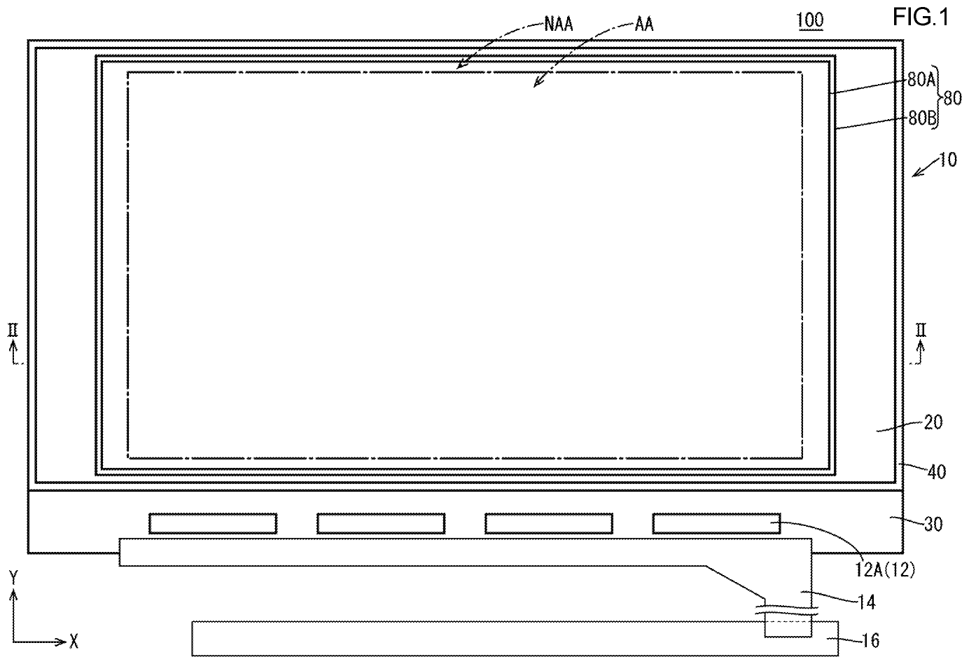

A first embodiment will be described with reference to FIGS. 1 to 11H. In this section, a liquid crystal display device 100 (one example of a display device) including a liquid crystal panel 10 (a display panel) will be described. In the drawings, X-axes, Y-axes, and Z-axes may be present. The axes in each drawing correspond to the respective axes in other drawings. Upper sides and the lower sides of the cross-sectional drawings correspond to the front side and the rear side of the liquid crystal panel 10.

As illustrated in a plan view of FIG. 1, the liquid crystal display device 100 at least includes the liquid crystal panel 10 displaying an image, a driver 12 configured to drive the liquid crystal panel 10, a control board 16 (a source board), a flexible circuit board 14, and a backlight unit. The control board 16 is a signal supply source that supplies various kinds of input signals to the driver 12 from an external device. The flexible circuit board 14 is a signal transmit section that electrically connects the control board 16 and each of the liquid crystal panel 10 and the driver 12. The backlight unit is disposed on a back side of the liquid crystal panel 10 and is an external light source that supplies light to the liquid crystal panel 10 for displaying.

As illustrated in FIG. 1, the liquid crystal panel 10 has a laterally-long rectangular overall shape and has a display surface that includes a display area AA (an active area) where an image is displayed and a non-display area NAA (a non-active area). The display area AA is a middle section of the display surface. The non-display area NAA is an outer peripheral section of the display surface having a frame shape that surrounds the display area AA. A long-side direction and a short-side direction of the liquid crystal panel 10 match the X-axis direction and the Y-axis direction in each drawing, respectively, and a thickness direction thereof matches the Z-axis direction in each drawing. In FIG. 1, an outline of the display area AA is represented by a chain line and an area outside the chain line is the non-display area NAA.

In the present embodiment, the non-display area NAA of the liquid crystal panel 10 includes one long-side section (a lower side in FIG. 1) having a larger area. Four drivers 12 are arranged at intervals along the X-axis direction in the larger area. The driver 12 is an LSI chip including a source driving circuit 12A, which will be described later, therein and is configured to process various kinds of signals transmitted via the flexible circuit board 14. The flexible circuit board 14 has one end that is connected to the non-display area NAA of the liquid crystal panel 10 and another end that is connected to the control board 16 and is configured to transmit various kinds of signals supplied from the control board 16 to the liquid crystal panel 10.

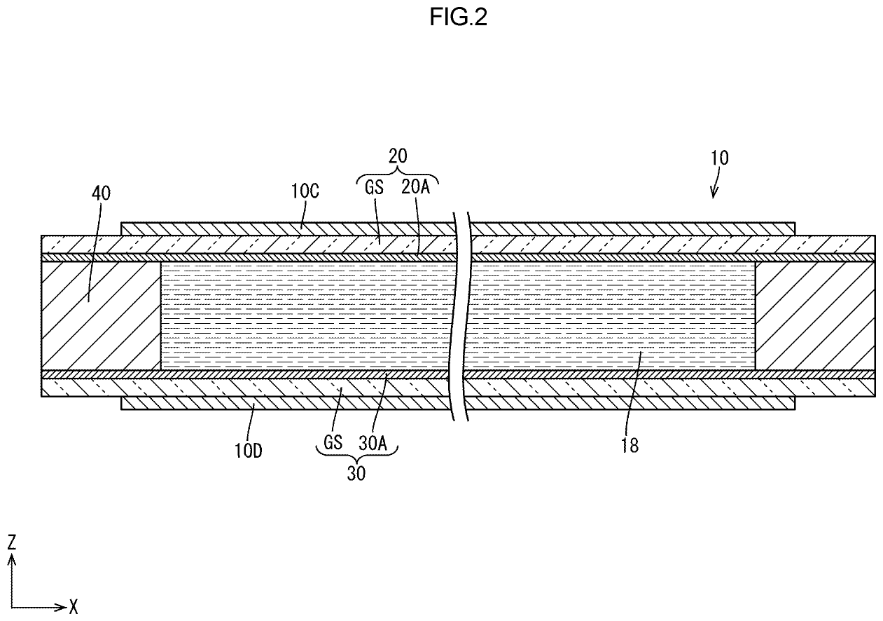

As illustrated in FIG. 2 (a cross-sectional view taken along line II-II in FIG. 1), the liquid crystal panel 10 at least includes a pair of substrates 20, 30, a liquid crystal layer 18, and a sealant 40. The liquid crystal layer 18 is disposed in an inner space between the substrates 20 and 30 and includes liquid crystal molecules that are substances whose optical characteristics change according to the application of an electric field. The sealant 40 is disposed between the substrates 20 and 30 to surround the liquid crystal layer 18 and seals the liquid crystal layer 18. One of the substrates 20, 30 on the front side (a front surface side) is a CF substrate 20 (an opposed substrate, a color filter substrate) and another one on the rear side (a rear-surface side) is an array substrate 30 (an active matrix substrate, a TFT substrate). The CF substrate 20 and the array substrate 30 include glass substrates GS (one example of an insulating substrate) and multi-layer films 20A, 30A on inner surfaces of the glass substrates GS, respectively. The multi-layer film 30A corresponds to a film forming section of the array substrate 30 except for the glass substrate GS. Polarizing plates 10C, 10D are bonded to outer surfaces of the substrates 20 and 30, respectively.

As illustrated in FIG. 1, the array substrate 30 has a long-side dimension that is substantially equal to a long-side dimension of the CF substrate 20 and has a short-side dimension that is greater than a short-side dimension of the CF substrate 20. Therefore, when the array substrate 30 and the CF substrate 20 are bonded to each other with the sealant 40 such that one long sides thereof are aligned with each other, the array substrate 30 has an uncovered section that does not overlap the CF substrate 20. The surface area of each of the substrates 20, 30 is defined into the display area AA and the non-display area NAA. The non-overlapping portion is a part of the non-display area NAA and the drivers 12 are mounted on the non-overlapping portion by the chip-on-glass (COG) mounting method and the flexible circuit board 14 is connected to the drivers 12. As illustrated in FIG. 1, the sealant 40 has a laterally-long frame shape an disposed on an outer peripheral edge of the CF substrate 20. The sealant 40 includes ultraviolet curing resin, for example, is cured by irradiation of the ultraviolet rays and changed into a solid state. Thus, the CF substrate 20 and the array substrate 30 are bonded to each other by the sealant 40. The sealant 40 keeps a distance between the substrates 20 and 30 (a thickness of the liquid crystal layer 18), that is, a cell gap to be constant.

As illustrated in the plan view of FIG. 3, source lines 43 (data lines, signal lines) and gate lines 44 (scanning lines) are routed in a grid to cross in the display area AA of the array substrate 30. Switching components (such as thin film transistors, TFTs) and pixel electrodes are disposed in respective sections surrounded by the source lines 43 and the gate lines 44. When a signal is input to the switching component from the source line 43 and the gate line 44, a potential of the pixel electrode that is connected to the switching component changes. An electric field that is to be applied to the liquid crystal layer 18 is controlled by the potential of the pixel electrode so that the orientation state of the liquid crystal molecules is switched as appropriate to drive the liquid crystal panel 10. The source lines 43, the gate lines 44, the switching components, and the pixel electrodes are sections of various kinds of patterned films included in the array substrate 30.

As illustrated in FIG. 3, the source lines 43 extend along the Y-axis direction (a vertical direction) and end portions of the source lines 43 that are extended to be in the non-display area NAA close to the driver 12 are connected to the drivers 12 via extended line sections 50. The extended line sections 50 are integrally formed with the array substrate 30 in a monolithic manner to connect the driver 12 and the source lines 43. With such a conductive path, the source lines are provided with data signals from the source driving circuit 12A of the driver 12 via the extended line sections 50.

As illustrated in FIG. 3, the gate lines 44 extend along the X-axis direction (a horizontal direction) and end portions of the gate lines 44 that are extended to be in the non-display area NAA on the right and left side portions (two short-side portions) of the non-display area NAA are connected to a gate driver monolithic circuit (GDM) section 60. The GDM section 60 is disposed in the non-display area NAA on the right and left side portions of the array substrate 30 in a monolithic manner. In this embodiment, the gate lines 44 are supplied with scanning signals from the two GDM sections 60 that are disposed on the right and left side sections of the array substrate 30. GDM line sections 70 are disposed in right and left portion of the non-display area NAA, respectively, and outside (on an outer peripheral edge side) the respective GDM sections 60. The GDM line sections 70 are formed on the array substrate 30 in a monolithic manner. The GDM line sections 70 are for supplying clock signals and power source voltages to the GDM sections 60.

As illustrated in FIG. 3, terminals 46 that are connected to an external device (the flexible circuit board 14) are arranged on a driver 12 side outer peripheral edge portion of the non-display area NAA. The terminals 46 are connected to the driver 12 and the GDM line section 70 by lines 47, 71 that are extended from the terminals 46. The terminals 46 are connected to one end of the flexible circuit board 14 and various kinds of input signals supplied from the control board 16 that is connected to another end of the flexible circuit board 14 are input to the terminals 46.

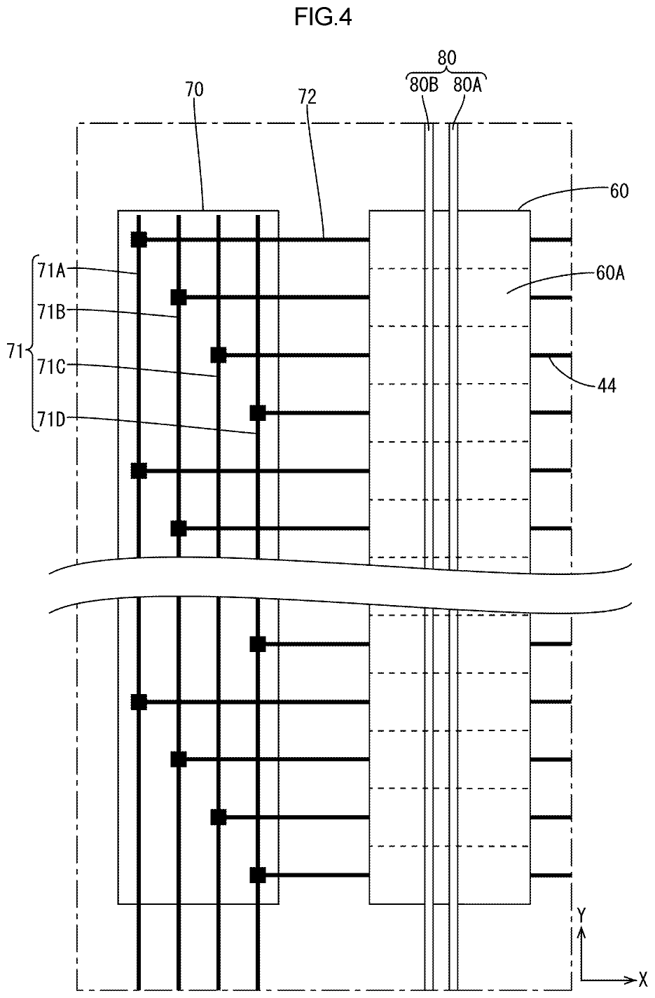

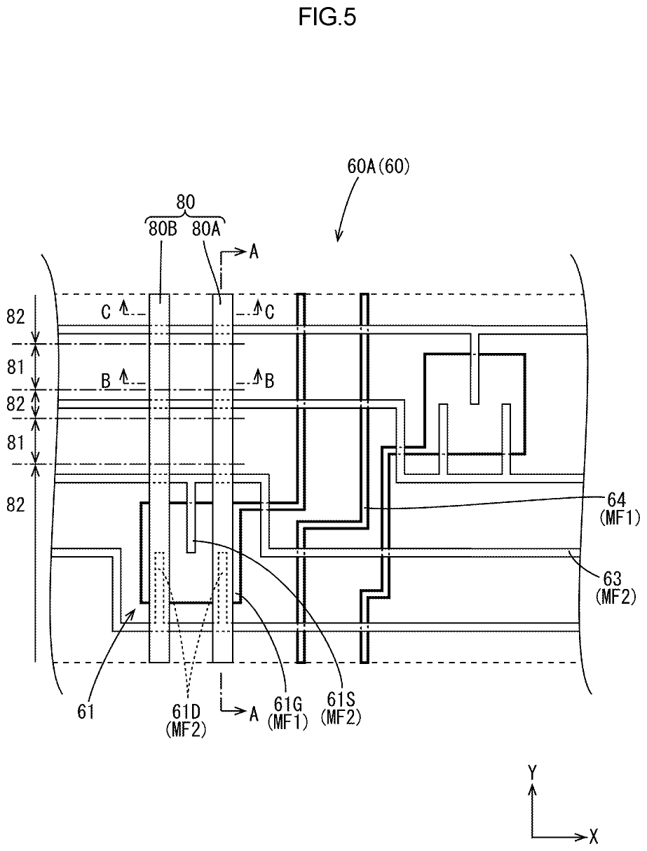

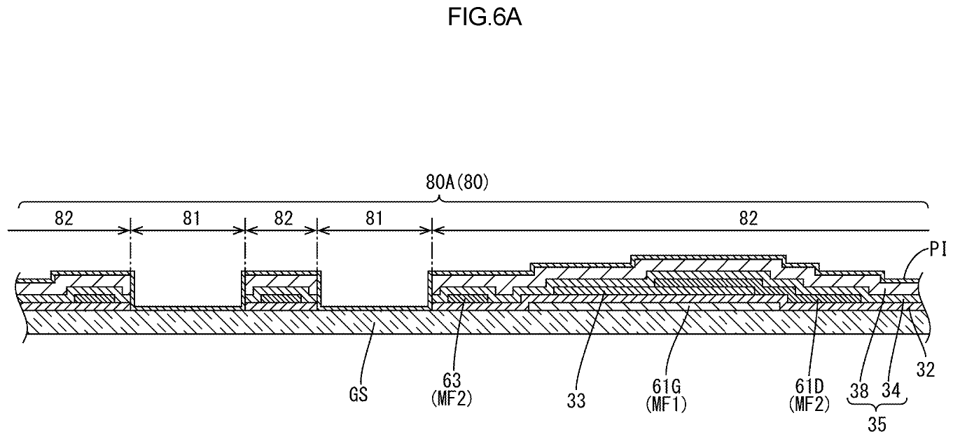

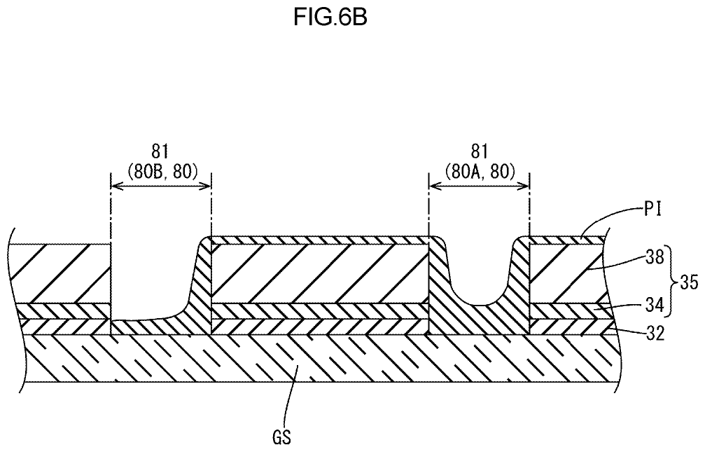

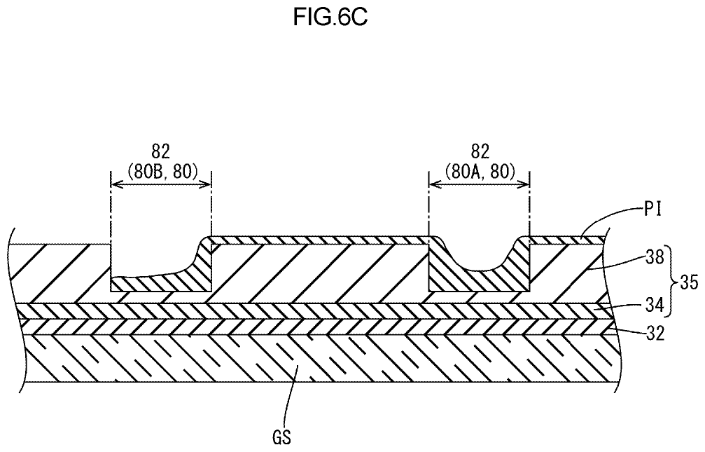

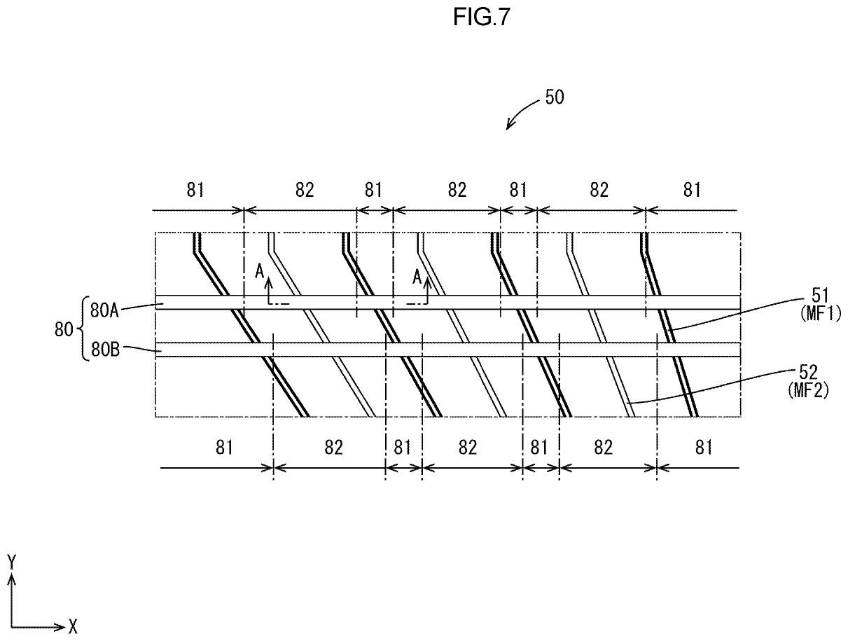

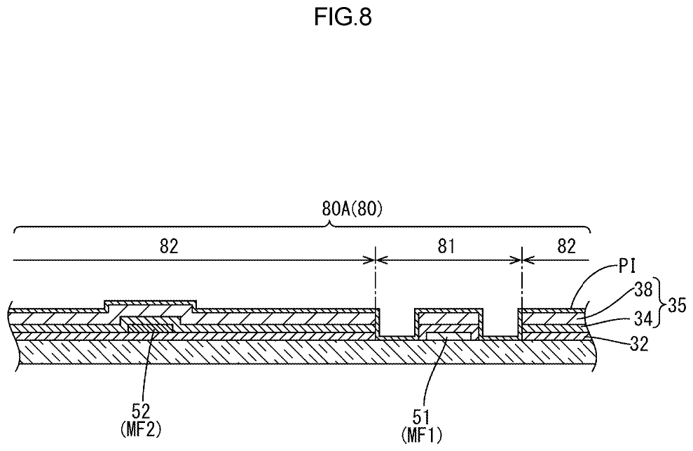

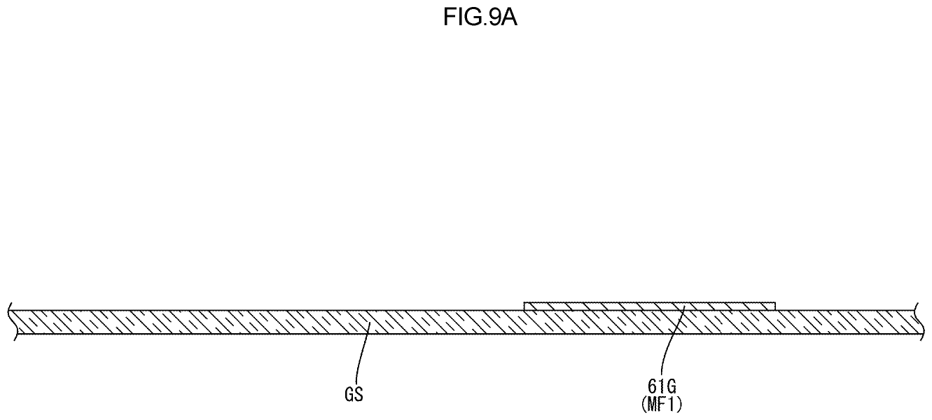

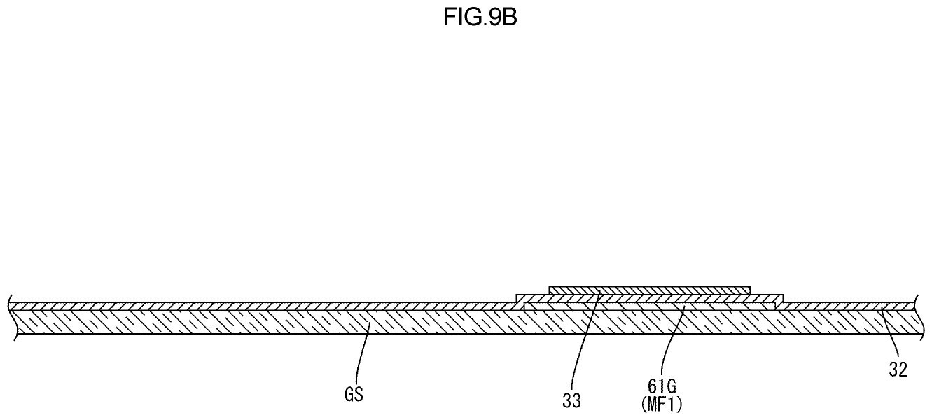

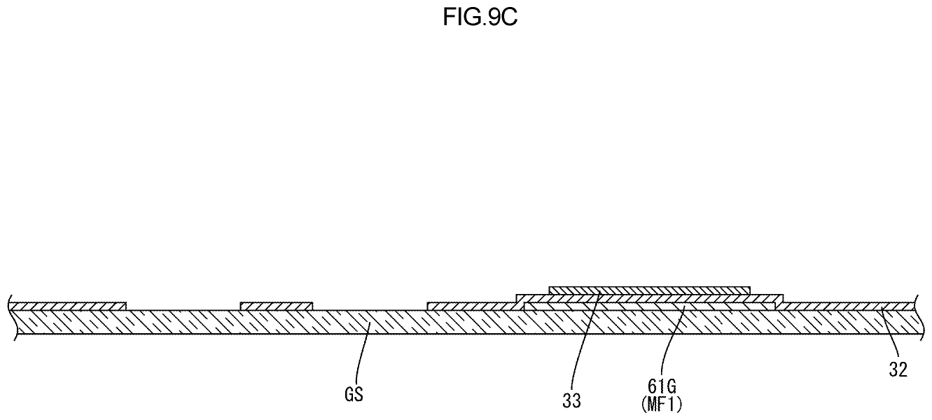

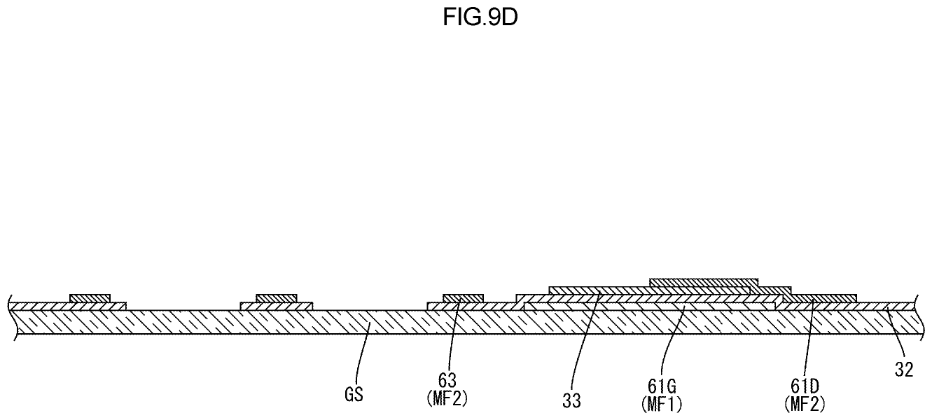

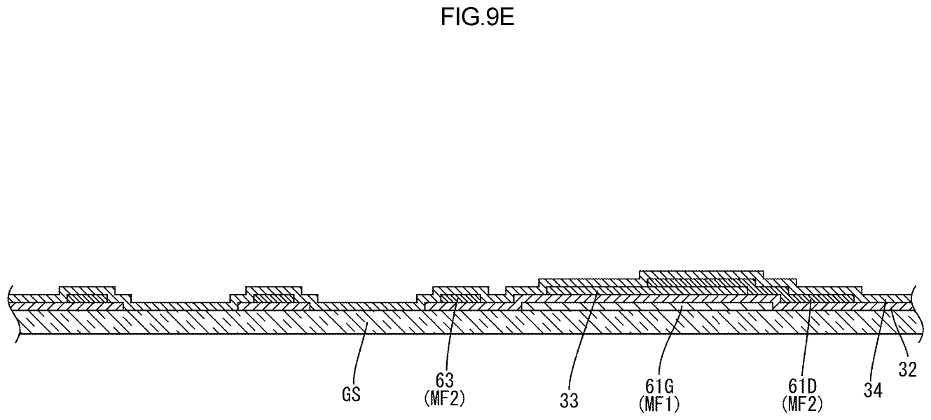

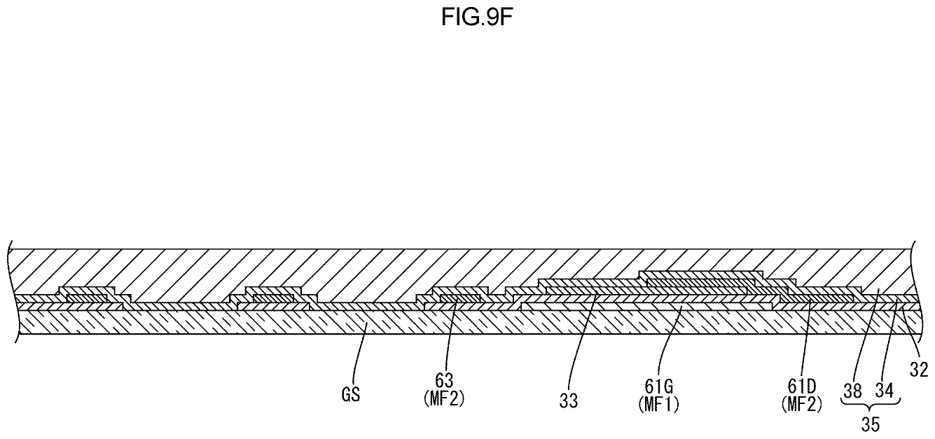

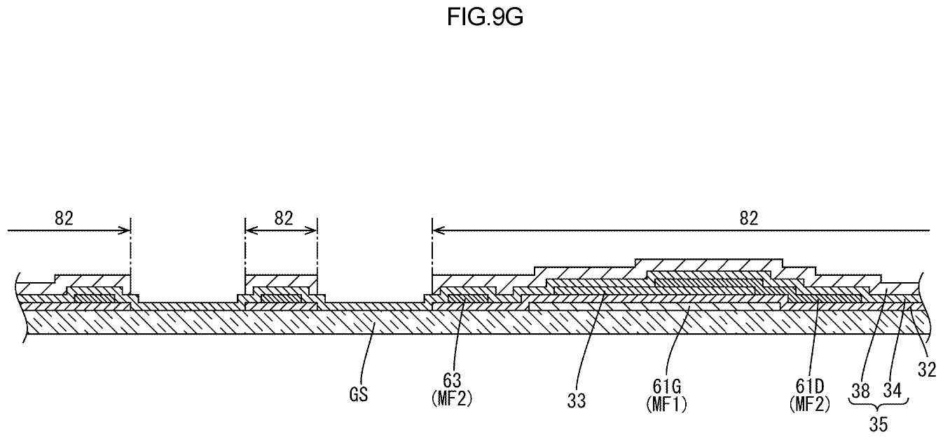

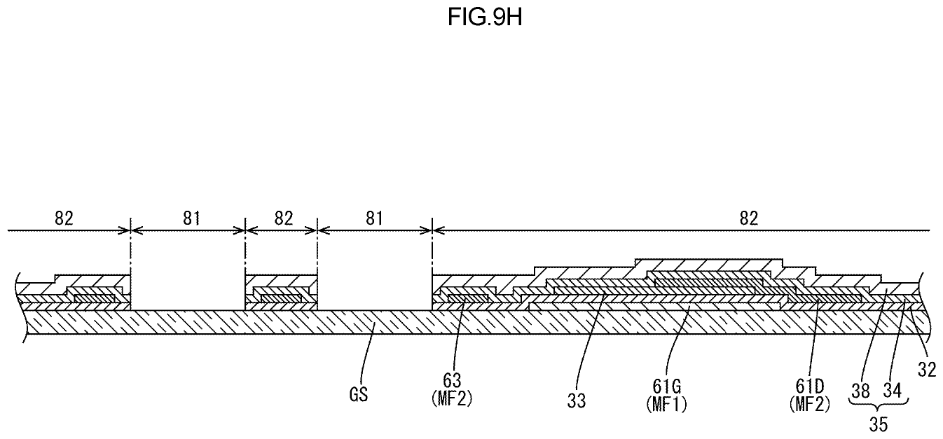

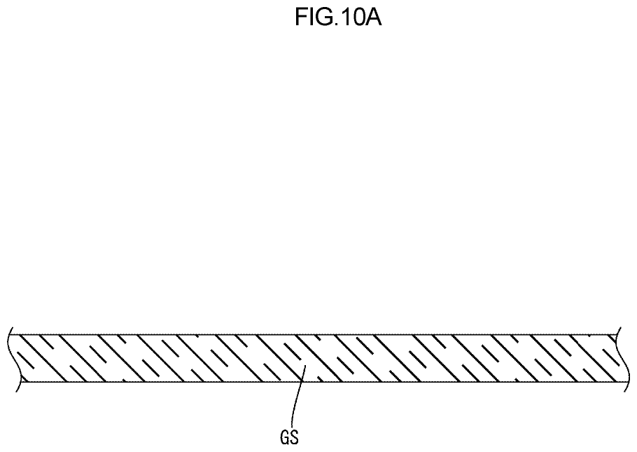

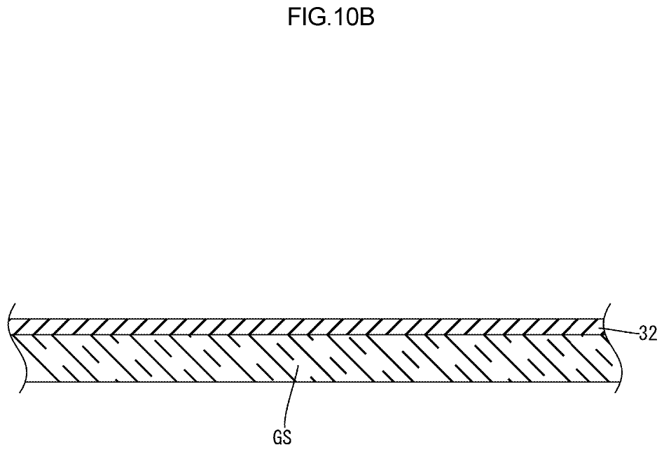

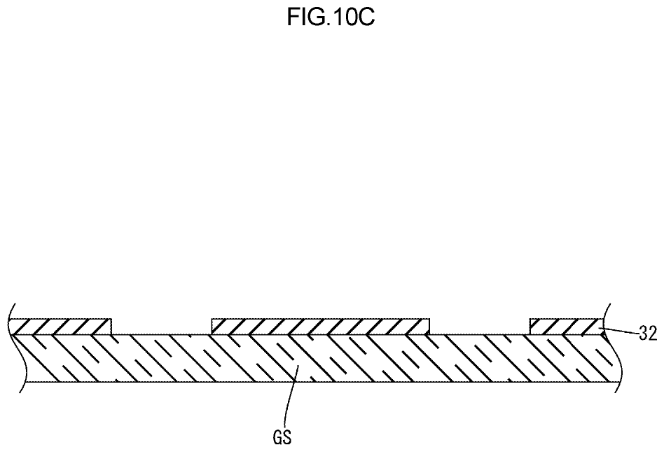

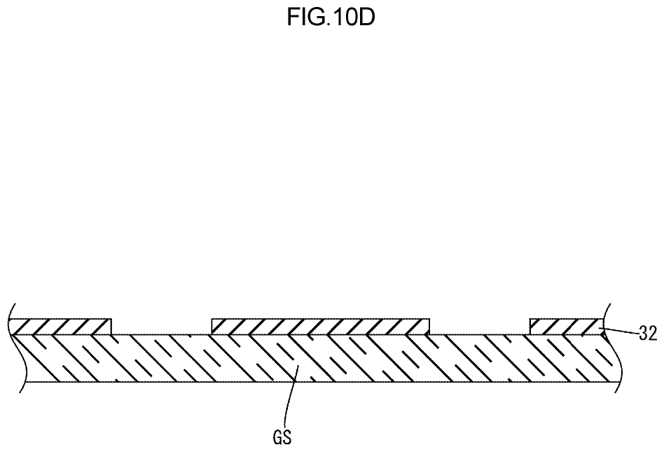

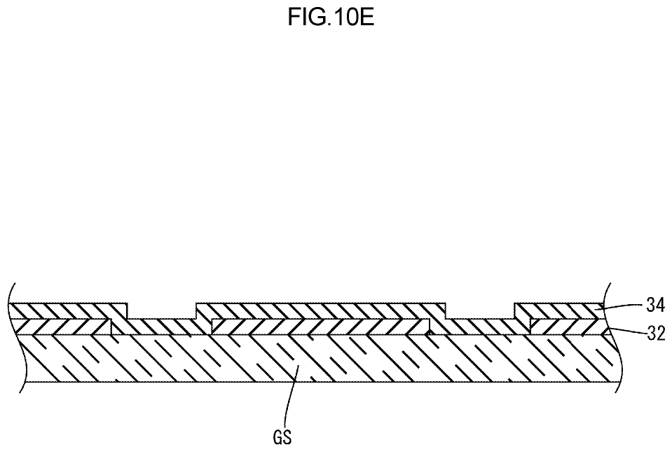

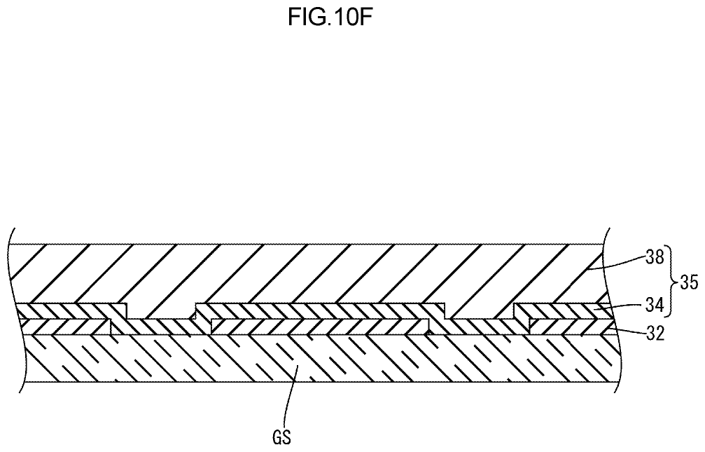

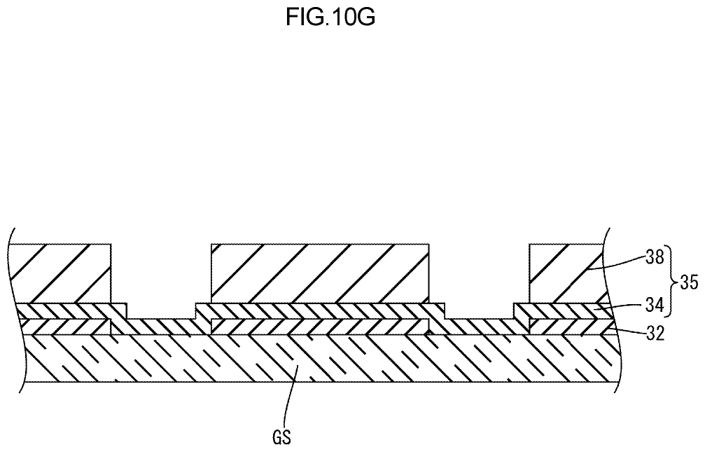

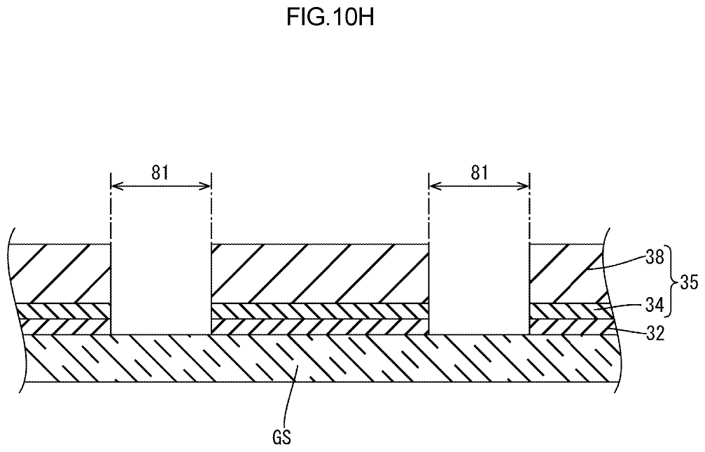

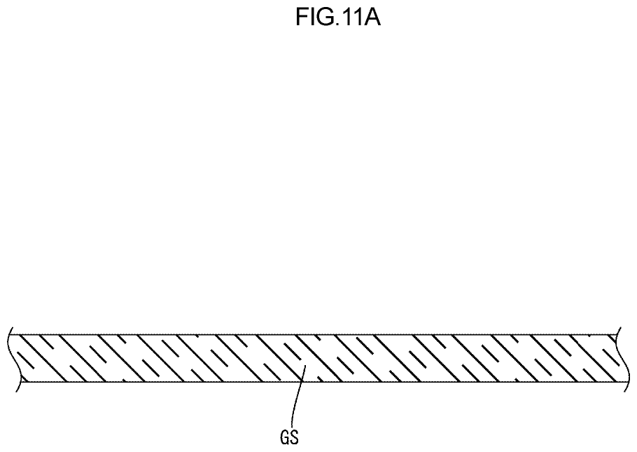

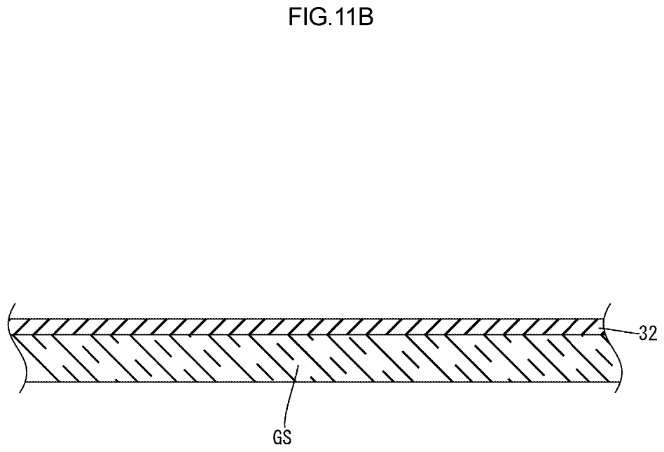

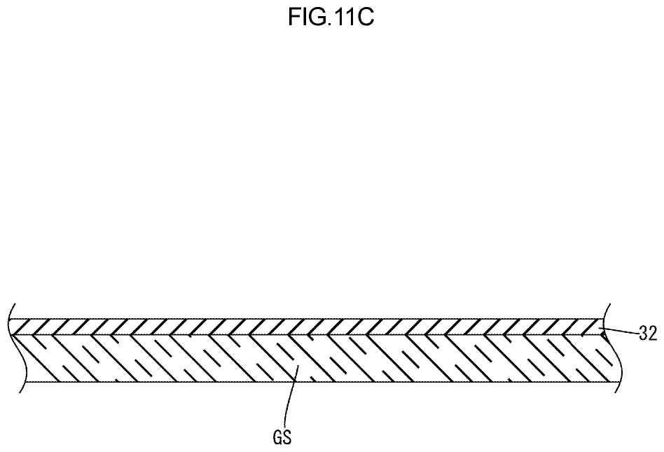

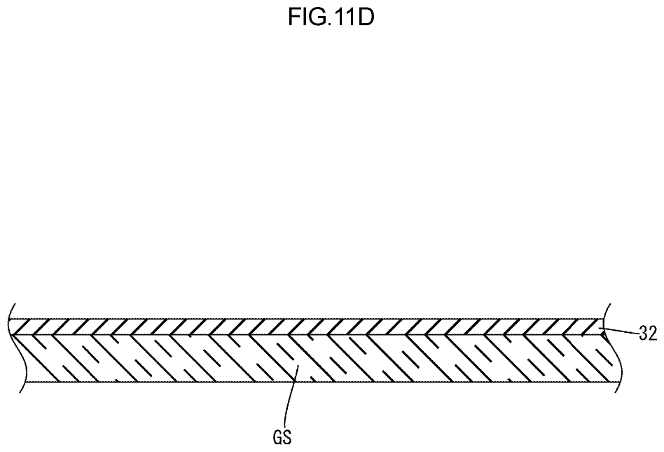

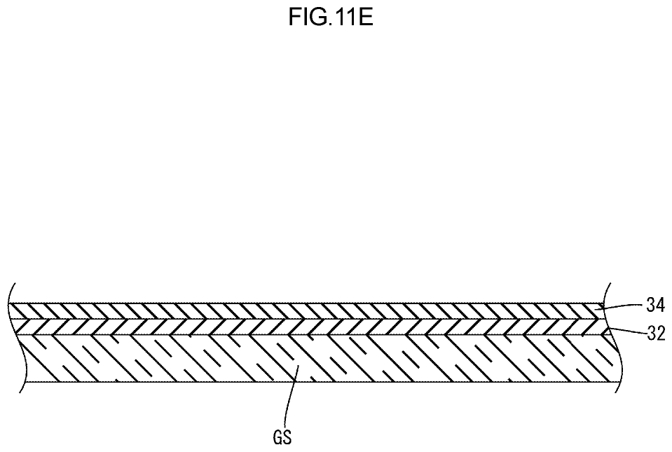

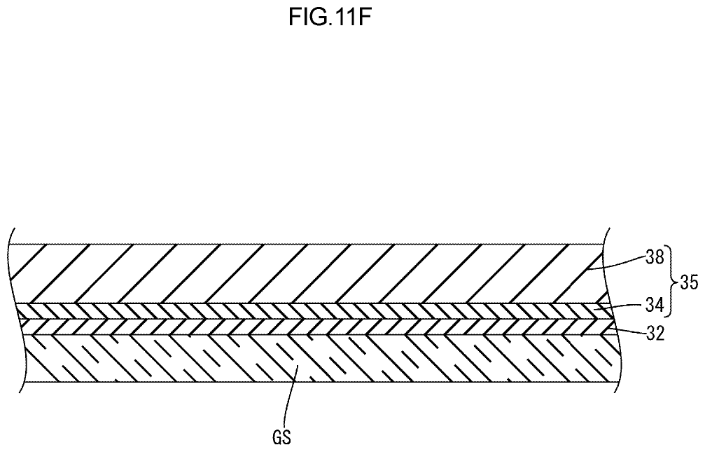

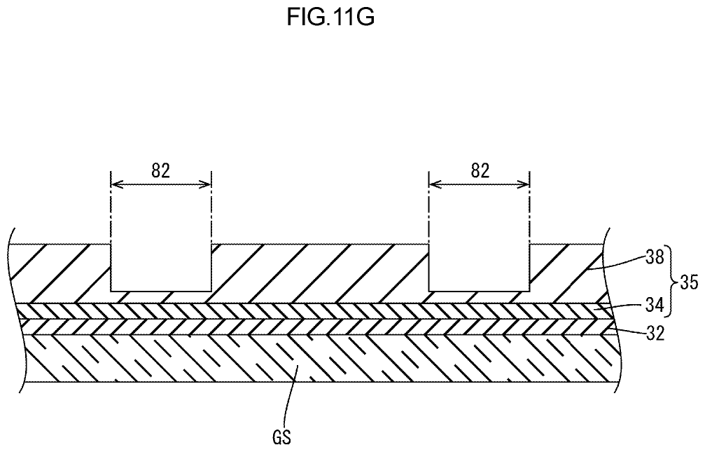

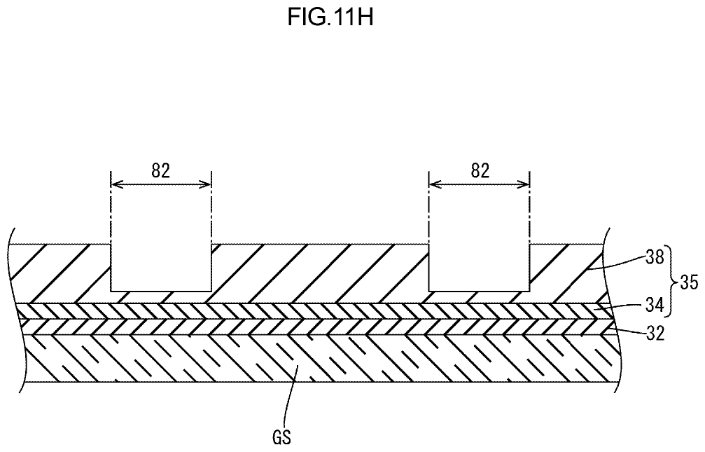

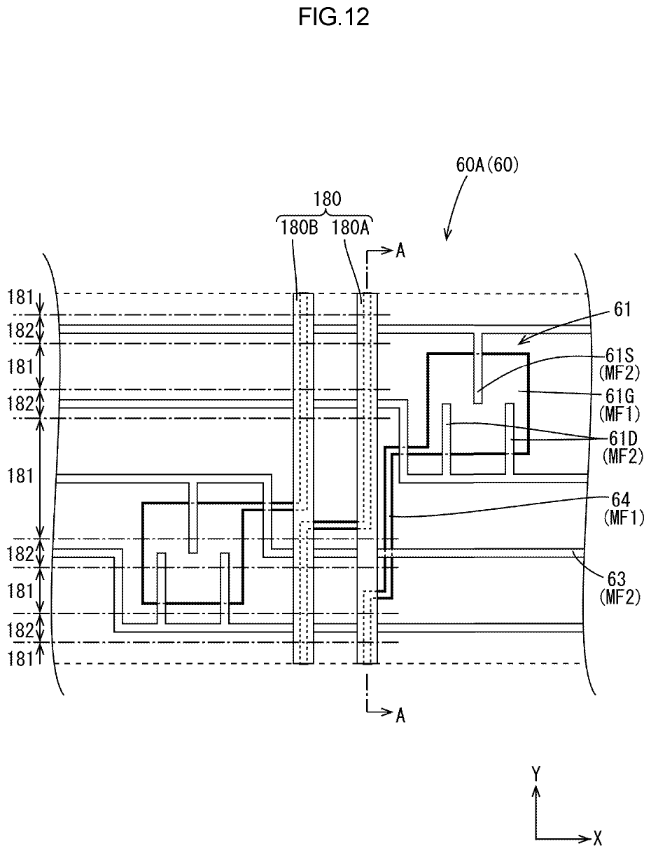

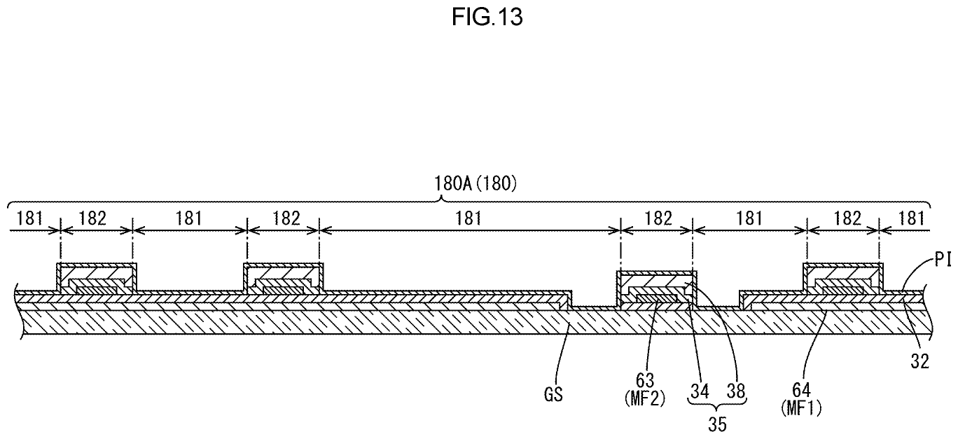

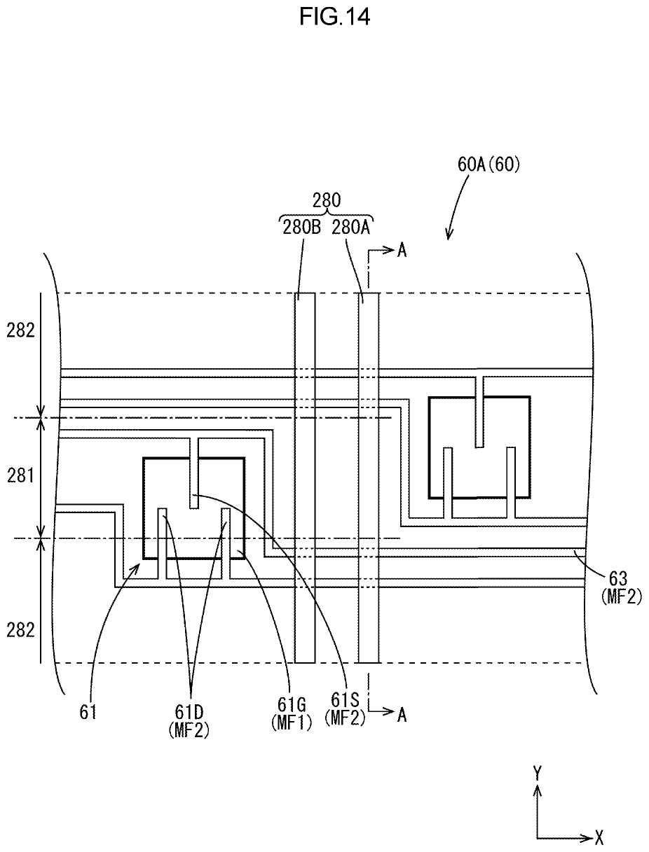

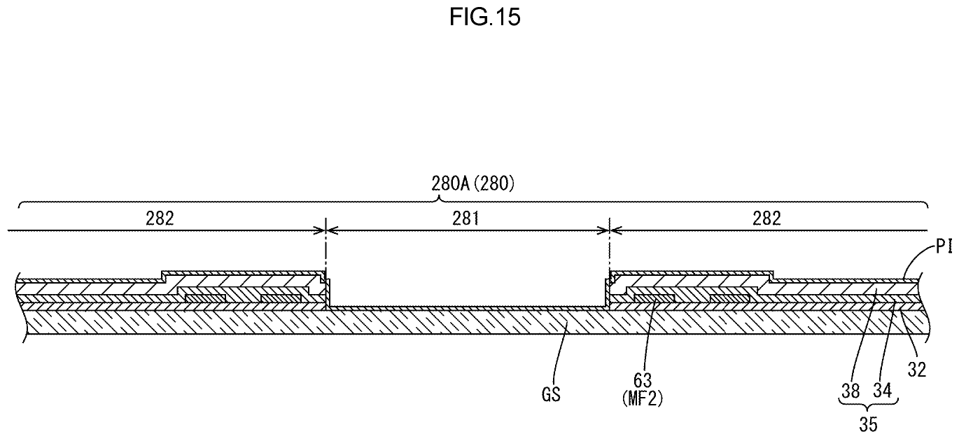

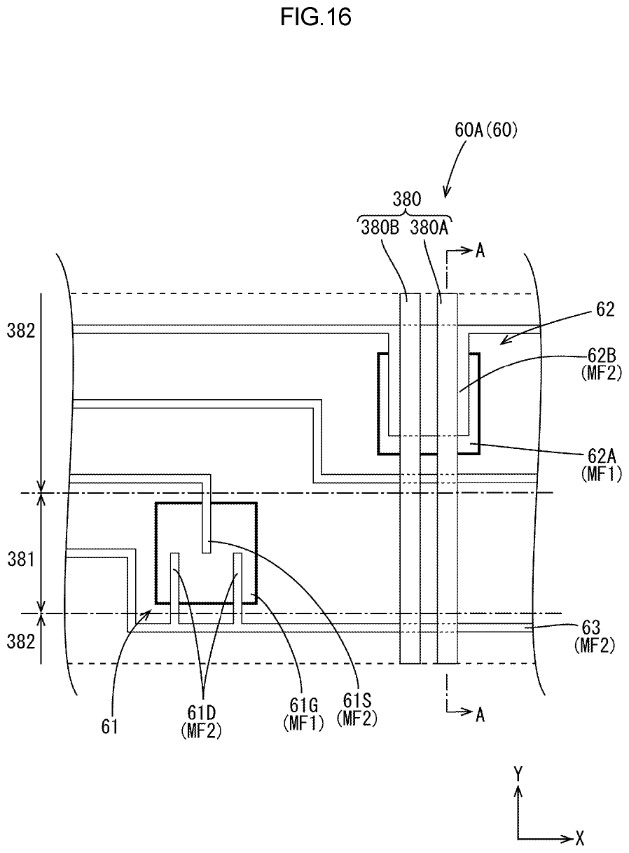

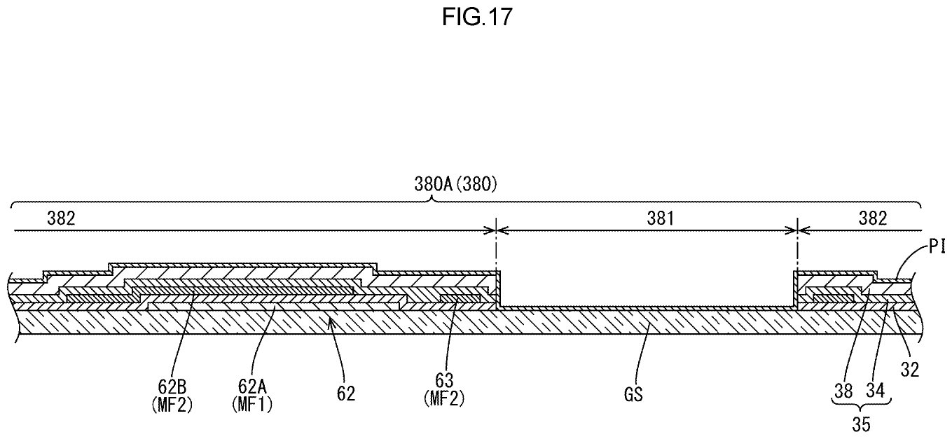

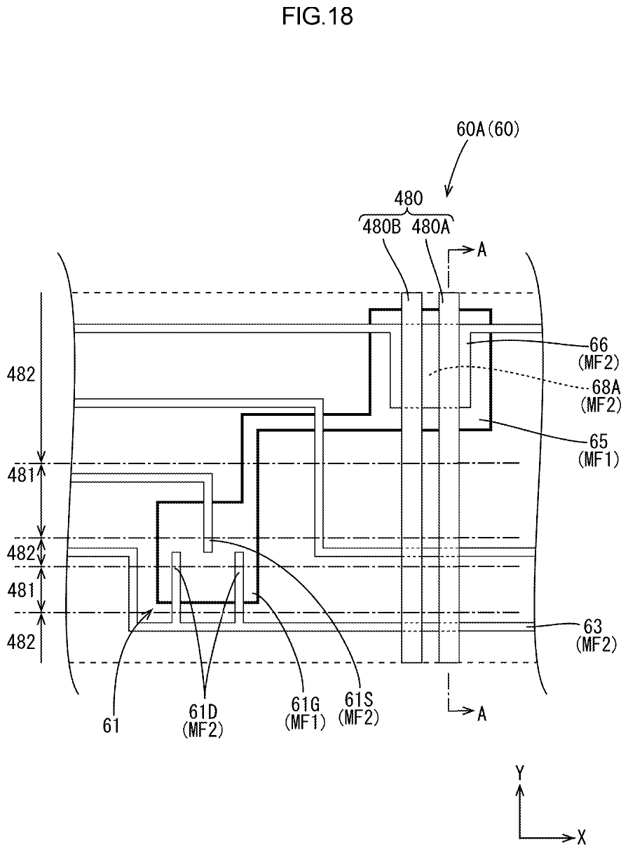

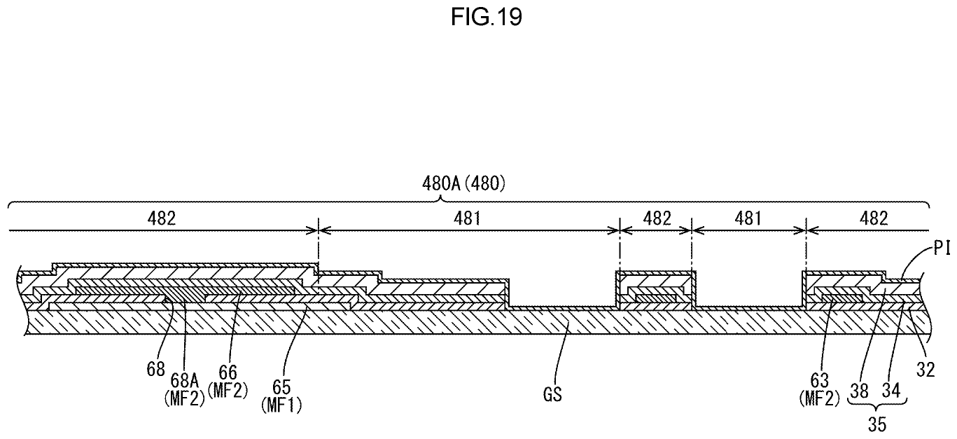

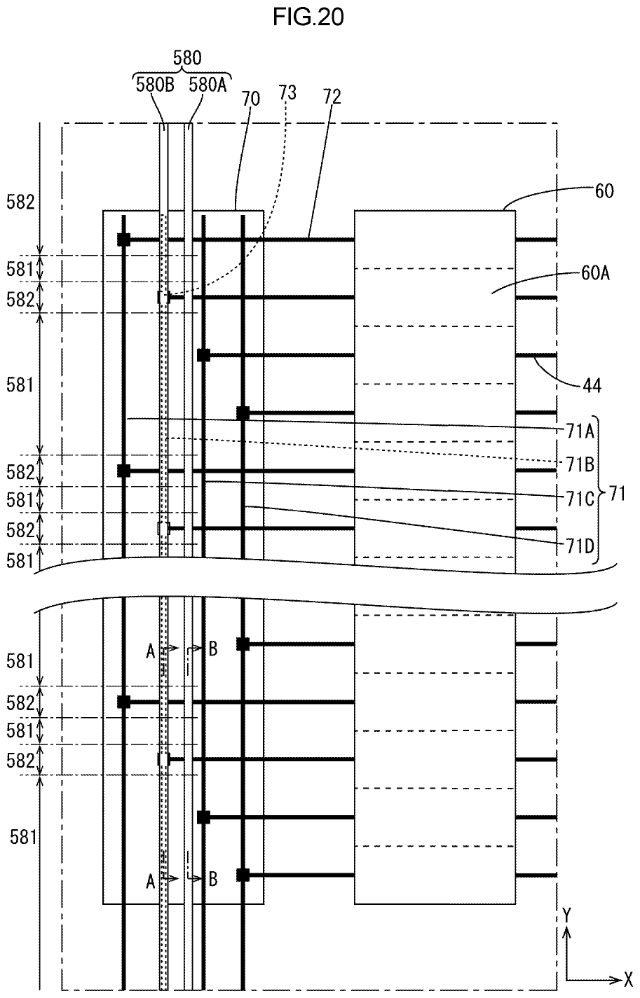

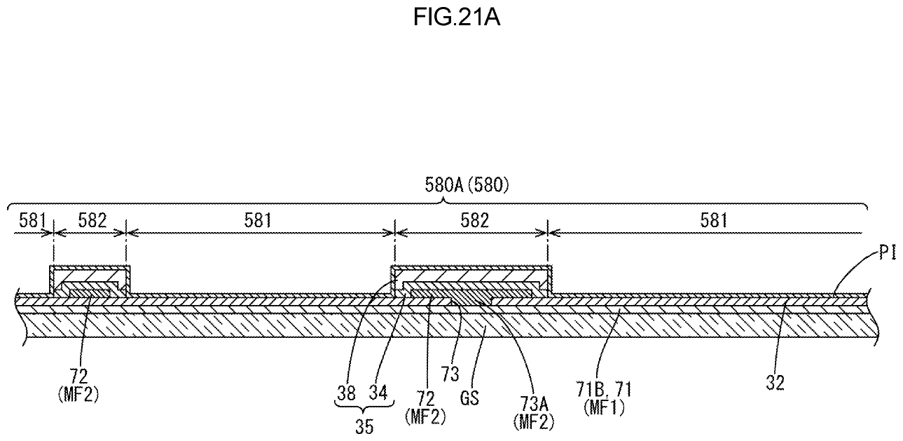

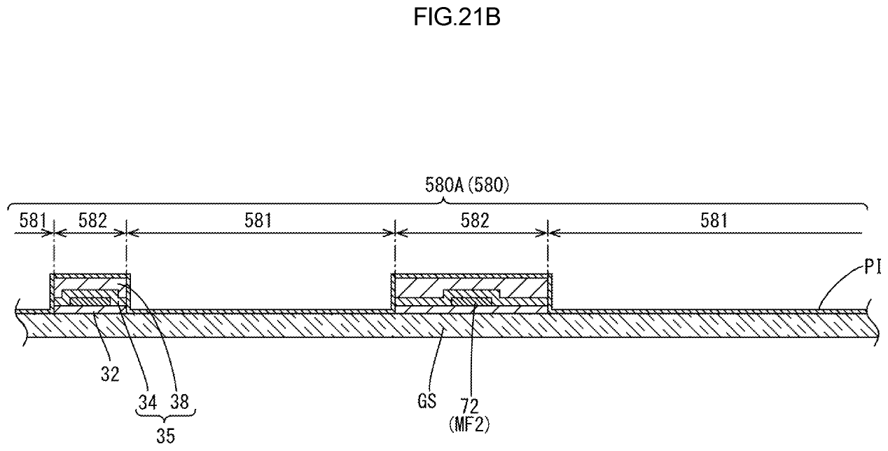

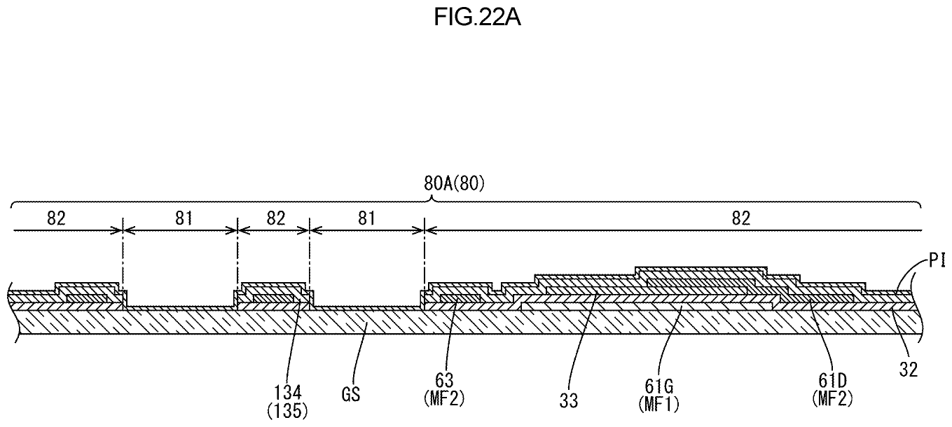

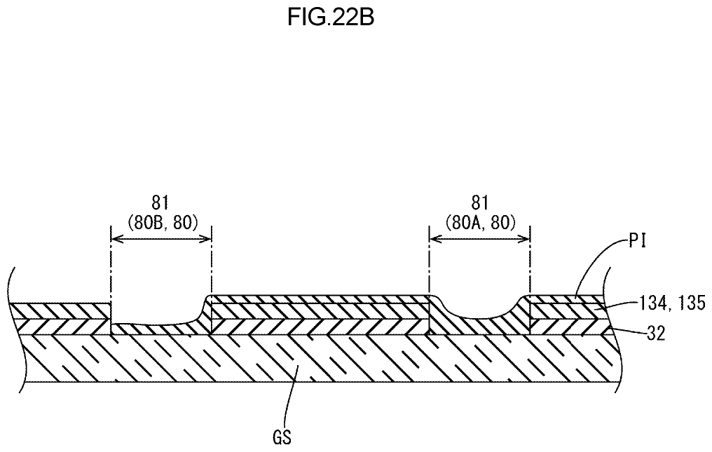

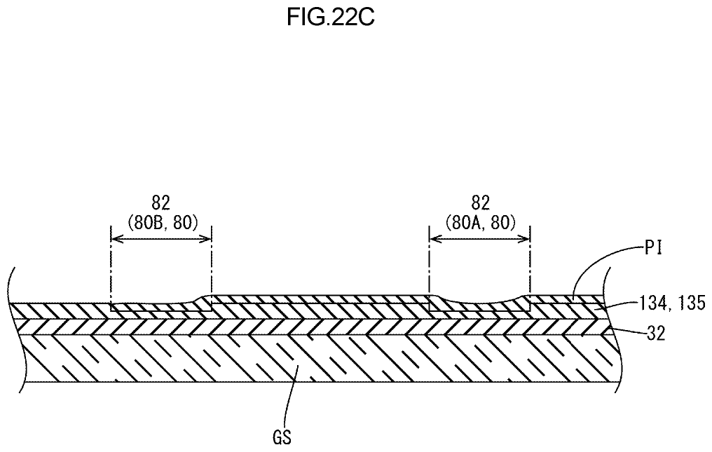

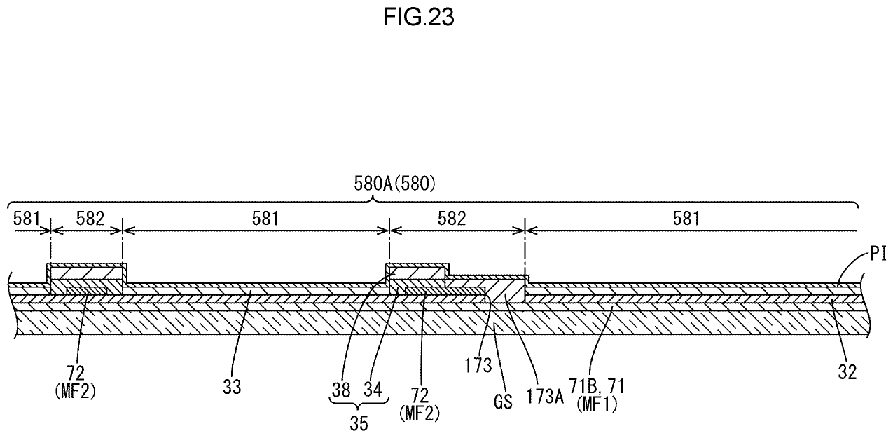

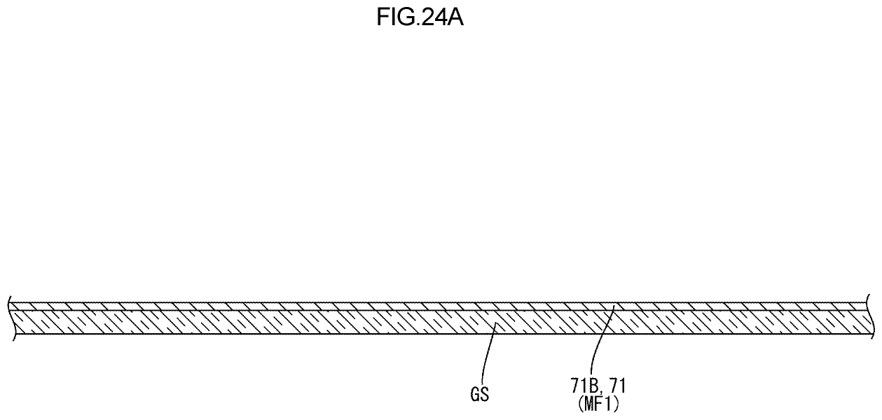

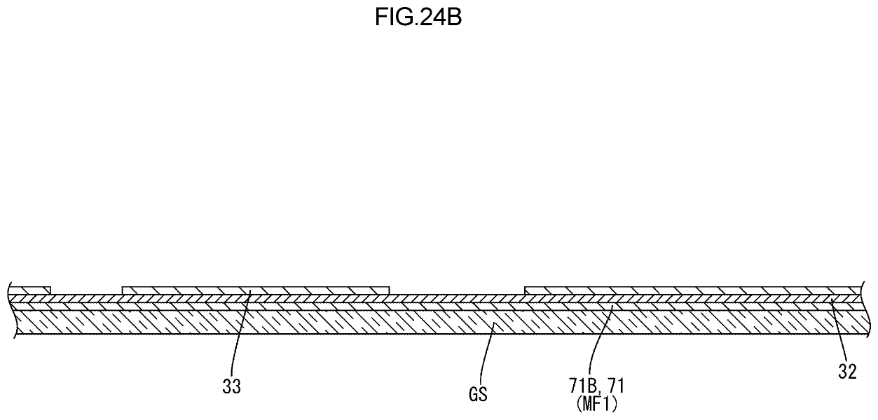

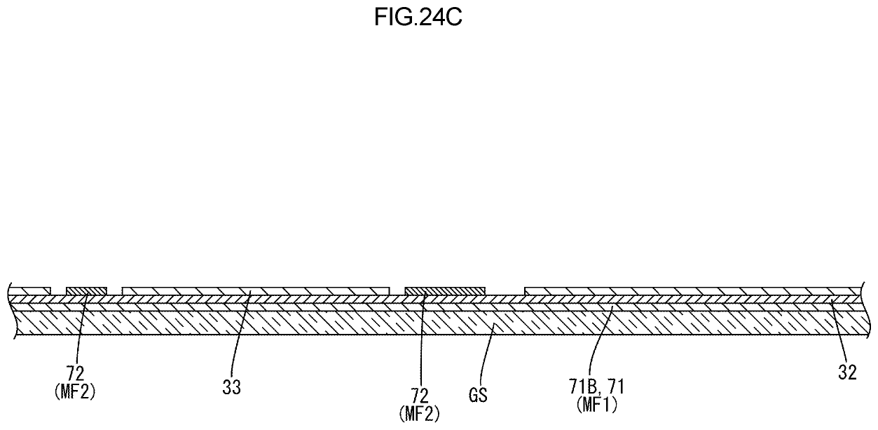

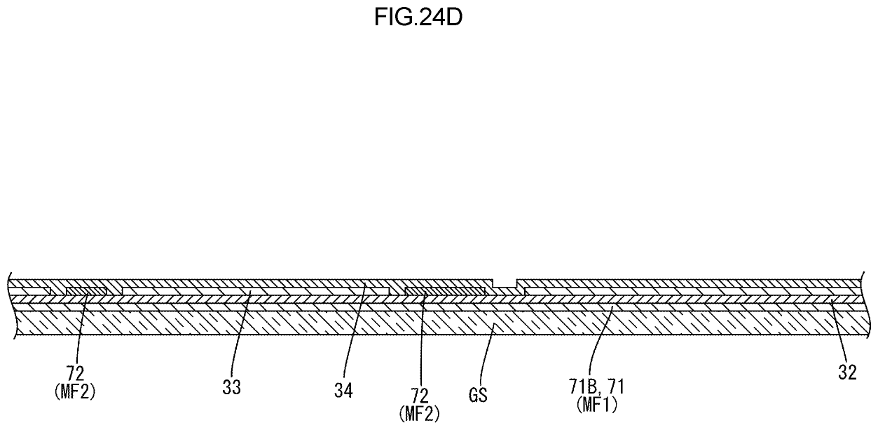

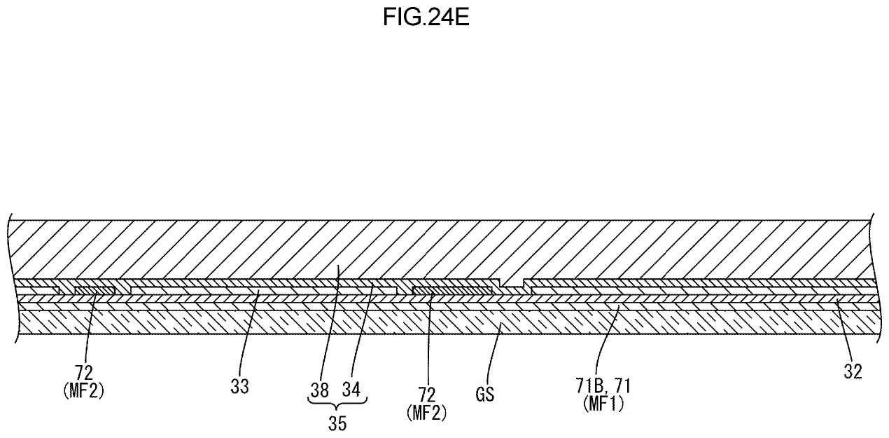

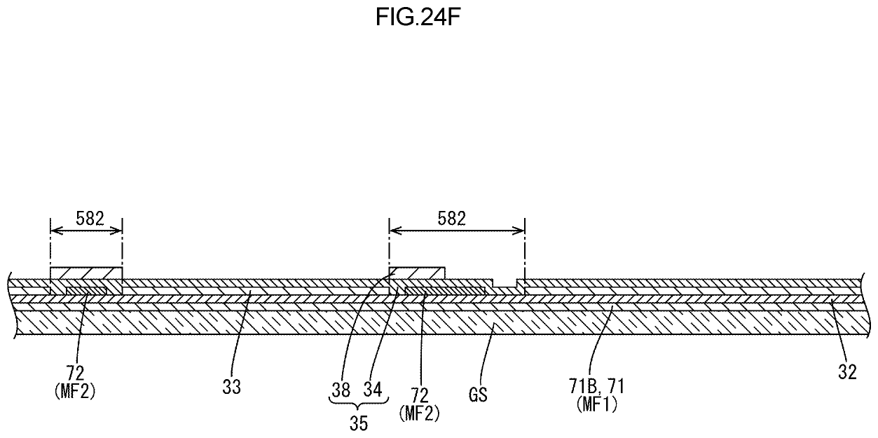

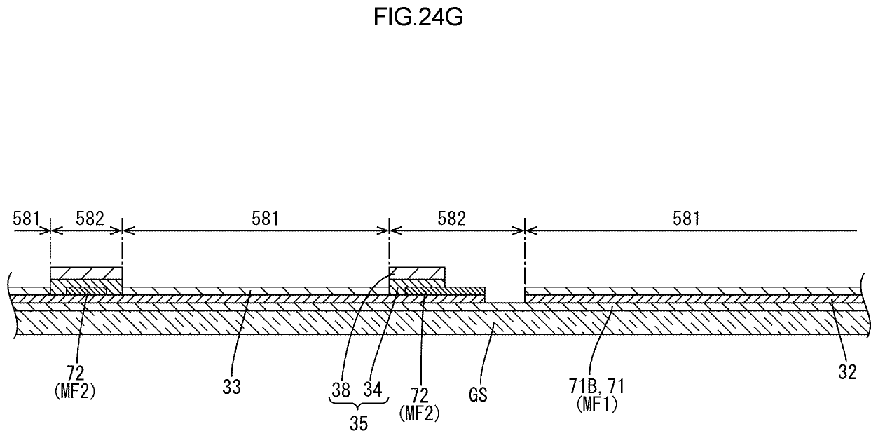

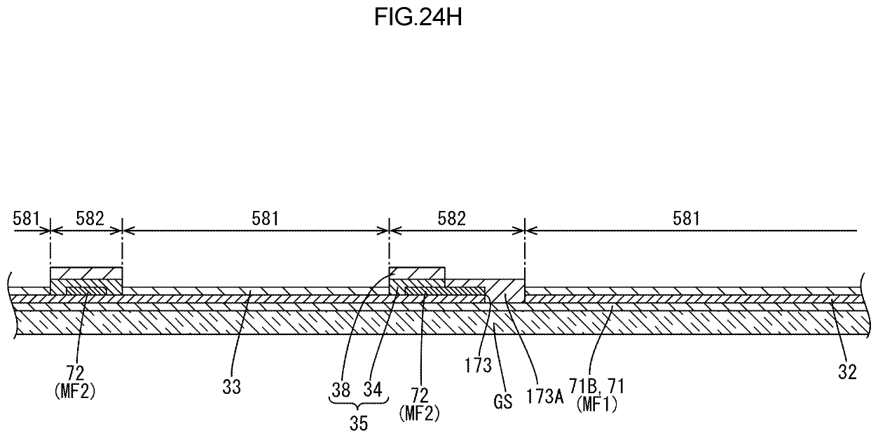

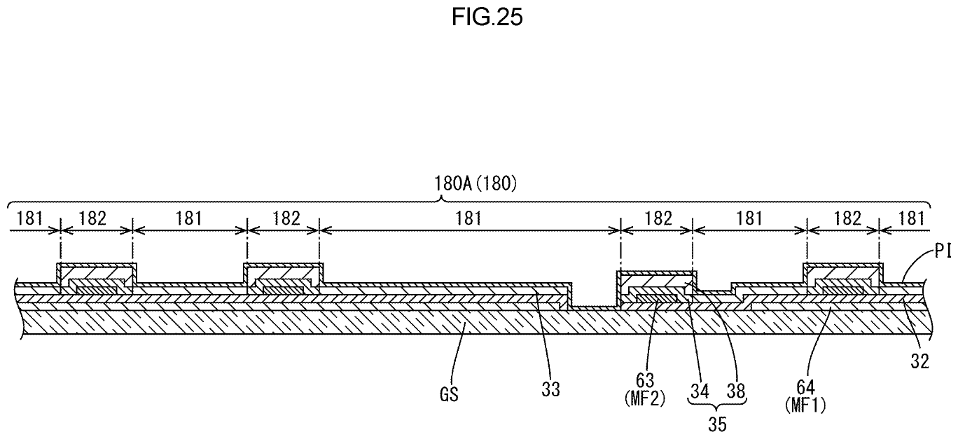

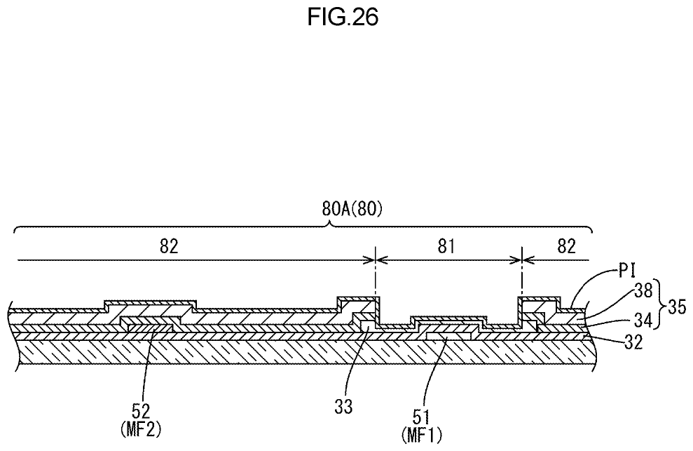

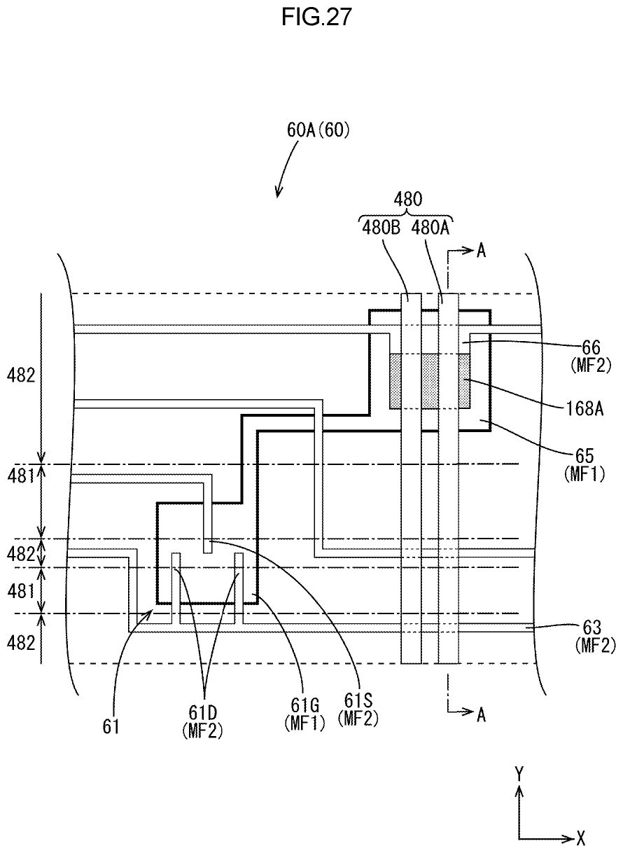

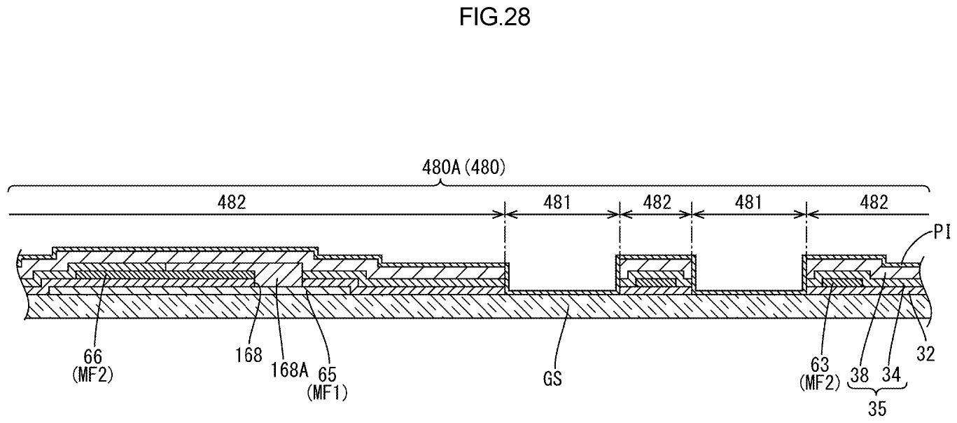

As illustrated in a plan view of FIG. 4 (an enlarged view of a structure within the frame IV in FIG. 3), the GDM line section 70 includes trunk lines 71 extending from the respective terminals 46 along the Y-axis direction and branch lines 72 extending from the trunk line 71 to a basic circuit 60A of the GDM section 60. The trunk lines 71 (four trunk lines 71A, 71B, 71C, 71D in FIG. 4) are arranged in parallel to each other and the trunk lines 71A, 71B, 71C, 71D are supplied with different signals (for example, first clock signals, second clock signals, third clock signals, fourth clock signals). The signal from the trunk line 71 is input to the GDM section 60 via the corresponding branch line 72. The GDM section 60 includes the basic circuits 60A of an arbitrary number n of stages (n: natural number). The basic circuit 60A in the nth stage outputs a scanning signal to the nth gate line 44. The basic circuit 60A may include a bootstrap circuit and includes TFTs 61 and capacitors 62.

According to the wiring structure described above, the signals from the control board 16 are supplied to the source lines 43 via the flexible circuit board 14, the terminals 46, the lines 47 extending from the terminals 46, and the source driving circuit 12A of the driver 12. The signals from the control board 16 are supplied to the gate lines 44 via the flexible circuit board 14, the terminals 46, the lines 71 (the trunk lines) extending from the terminals 46, the GDM line section 70, and the GDM section 60.

The array substrate 30 includes a groove portion 80 in a first insulating film 35 that is included in a layer lower than an alignment film PI to restrict a film forming area of the alignment film PI that is to be formed in an uppermost layer (a layer contacted with the liquid crystal layer 18). The alignment film PI is made of an organic insulating material such as polyimide resin and is contacted with the liquid crystal layer 18 to align the liquid crystal molecules included in the liquid crystal layer 18. In a process of producing the array substrate 30, droplets of the material for the alignment film PI are jetted on the display area AA by an ink jetting device and the material droplets are spread over a plate surface of the array substrate with wetting and the alignment film PI is formed. Therefore, material that has low viscosity and high fluidity is used for the alignment film PI such that the material is spread smoothly and film thickness unevenness is less likely to be caused. The area where the material of the alignment film PI flows is defined by the groove portion 80 such that the material is less likely to adhere to the portion where the sealant 40 is to be disposed or less likely to adhere to the terminals 46 that are connected to the driver 12 and the flexible circuit board 14. The sealant 40 has a good sealing property such that external moisture is less likely to enter the liquid crystal layer 18 and display errors are less likely to occur in the liquid crystal panel 10. Further, connection errors are less likely to occur in the driver 12 and the flexible circuit board 14.

As illustrated in FIGS. 1 and 3, the groove portion 80 is formed in the non-display area NAA of the array substrate 30 so as to surround an entire periphery of the display area AA. Specifically, the groove portion 80 has a laterally-long rectangular shape that is along an outline of the display area AA and is formed closer to the display area AA than the sealant 40 is. According to such a configuration, the spread of the material of the alignment film PI is restricted in all directions. In the present embodiment, the groove portion 80 includes (two) grooves including an inner groove 80A (relatively closer to the display area AA) and an outer groove 80B (relatively closer to the sealant 40) in a concentric manner. However, the groove portion 80 necessarily includes at least one groove. In a configuration including two grooves, even if the spread of the material of the alignment film PI is not restricted by the inner groove 80A in forming of the alignment film PI, the outer groove 80B can surely restrict the spread of the material of the alignment film PI.

As illustrated in FIG. 3, a driver 12 side long-side section of the groove portion 80 crosses the extended line sections 50, and short-side sections on both sides of the groove portion 80 cross the GDM sections 60. The array substrate 30 includes lines and components of the circuits that are sections of the various kinds of patterned thin films at the extended line sections 50 and the GDM sections 60. The groove portion 80 in this embodiment has two different depths depending on position relations between the groove portion 80 and a metal film (specifically, a source metal film MF2) that includes sections as the lines and the components of the circuits. As will be described later, the groove portion 80 includes a through portion 81 and a recess portion 82 that have different depth dimensions. Depending on the positon relations between the groove portion 80 and the source metal film MF2, areas of the through portion 81 and the recess portion 82 are adjusted. On the other hand, the array substrate 30 does not include various kinds of lines and the components of the circuits on the long-side section of the non-display area NAA that is opposite from the driver 12. Therefore, the position relations between the groove portion 80 and the source metal film MF2 need not to be considered in the long-side section of the non-display area NAA opposite from the driver 12, the long-side section opposite from the driver 12 includes only the through portions 81 and the depth of the groove section 80 is substantially constant.

Next, examples of the groove portion 80 will be described in detail with reference to FIGS. 5 to 6C. FIG. 5 illustrates an enlarged plan view illustrating a portion of (a portion including two TFTs 61) the basic circuit 60A included in the GDM section 60. As illustrated in FIG. 5, the groove portion 80 is formed to overlap the TFT 61 of the basic circuit 60A. GDM column lines 64 that are sections of a gate metal film MF1 and extend along the Y-axis direction are disposed near the TFT 61, and at least one of the GDM column lines 64 is connected to a gate electrode 61G of the TFT 61. Further, GDM row lines 63 that are sections of the source metal film MF2 extend along the X-axis direction and at least one of the GDM row lines 63 is connected to a source electrode 61S of the TFT 61 and another one of the GDM row lines 63 is connected to a drain electrode 61D of the TFT 61.

The array substrate 30 includes a glass substrate GS and the gate metal film MF1, a gate insulating film 32, a semiconductor film 33, the source metal film MF2, and the first insulating film 35 (a protection film 34 and a planarizing film 38) that are stacked on each other on the glass substrate GS in this order. The array substrate 30 further includes the alignment film PI disposed in an uppermost layer to cover the films and has a multilayer structure. As illustrated in FIG. 6A (a cross-sectional view taken along line A-A in FIG. 5), the TFTs 61 are bottom-gate type transistors and the TFT 61 includes the semiconductor film 33, the source electrode 61S, the drain electrode 61D, and the gate electrode 61G. The source electrode 61S and drain electrode 61D are disposed in a layer upper than the semiconductor film 33 and are sections of the source metal film MF2. The gate electrode 61G is disposed in a layer lower than the semiconductor film 33 via the gate insulating film 32 and is a section of the gate metal film MF1. Each of the gate metal film MF1 and the source metal film MF2 is a single-layer film made of one kind of metal or a multilayer film made of multiple kinds of metals, such as copper (Cu) and other metals. The two metal films MF1, MF2 may include the same material or different materials. The semiconductor film 33 includes an oxide semiconductor including indium gallium zinc oxide (IGZO). The gate insulating film 32 is made of a transparent inorganic insulating material and is a single-layer film or a multilayer film made of one or some of the materials of silicon oxide (SiOₓ), silicon oxynitride (SiON), and silicon nitride (SiNx). The gate insulating film 32 establishes insulation between the gate electrode 61G and the semiconductor film 33. The gate insulating film 32 protects the gate electrode 61G (the gate metal film MF1) from absorbing moisture.

The groove portion 80 is formed in the first insulating film 35 that is disposed between the source metal film MF2 and the alignment film PI. In this embodiment, the first insulating film 35 is a two-layer film including the protection film 34 (a passivation film, an inorganic insulating film) and the planarizing film 38 (an organic insulating film) that is included above the protection film 34. The protection film 34 is made of an inorganic insulating material such as silicon nitride (SiNx) and silicon oxide (SiO₂) and covers and protects the source metal film MF2 such that the source metal film MF2 does not absorb moisture and the metal characteristics thereof are not deteriorated. The protection film 34 has a film thickness of about 0.2 μm, for example. The planarizing film 38 is made of a transparent organic insulating material such as acrylic resin (PMMA) and polyimide resin and has a film thickness of about 2.0 μm, for example. The film thickness of the planarizing film 38 is greater than that of other insulating films (the gate insulating film 32, the protection film 34). The planarizing film 38 having great thickness planarizes the surface of the display area AA of the array substrate 30.

As illustrated in FIGS. 6B and 6C (a cross-sectional view taken along line B-B and a cross-sectional view taken along line C-C in FIG. 5), the groove portion 80 includes the through portions 81 that extend through the first insulating film 35 (the protection film 34 and the planarizing film 38) and the recess portions 82 that do not extend through the first insulating film 35 and are recessed in the first insulating film 35. As illustrated in FIGS. 6A and 6B, a section of the first insulating film 35 (the protection film 34 and the planarizing film 38) corresponding to the through portion 81 is removed entirely in the thickness direction. On the other hand, as illustrated in FIGS. 6A and 6C, the film thickness of the protection film 34 is constant and the film thickness of the planarizing film 38 is greatly reduced in the recess portion 82. Therefore, the first insulating film 35 is recessed by the decreased amount of the film thickness of the planarizing film 38 in the recess portion 82. As illustrated in FIGS. 5 and 6A, the through portion 81 and the recess portion 82 extend continuously with a constant width and have different depths in the extending groove portion 80.

As illustrated in FIGS. 5 and 6A, the through portions 81 are formed not to overlap the GDM row line 63 that is a section of the source metal film MF2 and the TFT 61 including the source electrode 61S and the drain electrode 61D that are sections of the source metal film MF2. The recess portions 82 are formed to overlap the GDM row line 63 and the TFT 61. Namely, the through portions 81 do not overlap the source metal film MF2 and the recess portions 82 overlap at least the source metal film MF2.

The alignment film PI is disposed in a layer upper than the first insulating film 35 and in the display area AA and a section of the non-display area NAA that is inside (closer to the display area AA) the groove portion 80. Various kinds of alignment films such as an alignment film for alignment by rubbing, a photo-alignment film for alignment by light of a specific wavelength region (for example, ultraviolet rays), and other alignment films may be used as the alignment film PI. A vertical alignment film or a horizontal alignment film may be used. As described earlier, the alignment film PI is disposed by spreading the droplets of the material along the plate surface of the array substrate 30. As is obvious from FIGS. 6B and 6C, the alignment film PI extends over the inner groove 80A but does not extend over the outer groove 80B and the spread of the material is restricted by the groove portion 80. Since the groove portion 80 includes the through portions 81 having a great depth, the capacity of the groove portion 80 is increased. In the recess portions 82, the source metal film MF2 is covered with the first insulating film 35 such that the source metal film MF2 is less likely to be deteriorated by absorbing moisture.

As illustrated in FIGS. 6A and 6B, a section of the gate insulating film 32, which is included in a layer lower than the protection film 34, corresponding to the through portion 81 is preferably removed entirely in the thickness direction. Namely, the through portion 81 preferably extends through the gate insulating film 32. According to such a configuration, the through portion 81 becomes deeper, and the capacity for storing the material for the alignment film PI is increased. Accordingly, the spread of the material for the alignment film PI is restricted more surely. However, as illustrated in FIG. 8, a portion of the gate insulating film 32 corresponding to the through portion 81 and overlapping the metal film MF1 is not removed to protect the gate metal film MF1 from absorbing moisture.

Next, the groove portion 80 that crosses the extended line sections 50 will be described. As illustrated in FIG. 7, the extended line sections 50 include first extended lines 51 that are sections of the gate metal film MF1 and second extended lines 52 that are sections of the source metal film MF2. The first extended lines 51 and the second extended lines 52 are arranged alternately and in parallel to each other. As illustrated in FIG. 8 (a cross-sectional view taken along line A-A in FIG. 7), the first extended lines 51 and the second extended lines 52 are sections of different metal films MF1 and MF2, respectively, and included in different layers. Therefore, compared to a configuration including only a metal film included in a same layer, that is, including only the second extended lines 52, which are sections of the source metal film MF2 to obtain the same number of lines, the interval (a line pitch) between the extended lines becomes smaller.

As illustrated in FIGS. 7 and 8, the through portions 81 do not overlap the second extended lines 52, which are sections of the source metal film MF2, but overlap the first extended lines 51, which are sections of the gate metal film MF1. The recess portions 82 are formed to overlap the second extended lines 52. Namely, the through portions 81 do not overlap the source metal film MF2 and the recess portions 82 overlap the source metal film MF2. Since the groove portion includes the through portions 81 having a great depth dimension, the capacity for storing the material for the alignment film PI is increased. The source metal film MF2 is covered with the first insulating film 35 in the recess portions 82 such that the source metal film MF2 is less likely to be deteriorated by absorbing moisture. A section of the gate insulating film 32 corresponding to the through portion 81 that does not overlap the gate metal film MF1 is entirely removed in the thickness direction. According to such a configuration, the through portion 81 becomes much deeper, and the capacity for storing the material for the alignment film PI is increased. Accordingly, the spread of the material for the alignment film PI is further restricted. However, a portion of the gate insulating film 32 corresponding to the through portion 81 and overlapping the metal film MF1 is not removed to protect the gate metal film MF1 from absorbing moisture. As illustrated in FIG. 7, areas of the through portions 81 and the recess portions 82 can be defined independently in each of the inner groove 80A and the outer groove 80B.

The configuration of the groove portion 80 according to the present embodiment is described above, and a method of producing the array substrate 30 including the groove portion 80 having the above configuration will be described next with reference to an example of the cross-sectional portion illustrated in FIG. 6A. The array substrate 30 is produced by forming thin film patterns of the various kinds of thin films on the glass substrate GS in the sequence illustrated from FIGS. 9A to 9H and forming the alignment film PI on the multilayer film illustrated in FIG. 9H.

For forming the array substrate 30 in this embodiment, the gate metal film MF1 is disposed over an entire area of the glass substrate GS first and the gate metal film MF1 is patterned with the known photolithography method to form the gate electrode 61G (FIG. 9A). The photolithography method is a general method including processes of the resist film coating, the resist film exposing (forming a resist pattern), and etching with using the resist pattern as a mask and detailed explanation thereof is omitted. Next, the gate insulating film 32 and the semiconductor film 33 are disposed on the gate electrode 61G sequentially, and the semiconductor film 33 is patterned (FIG. 9B) and thereafter, the gate insulating film 32 is patterned (FIG. 9C). The source metal film MF2 is disposed on the gate insulating film 32 and patterned to form the drain electrode 61D and the GDM row line 63 (FIG. 9D). Then, the protection film 34 and the planarizing film 38 are disposed sequentially (FIGS. 9E and 9F). The sections of the planarizing film 38 corresponding to the through portions 81 are removed entirely in the film thickness direction and the sections thereof corresponding to the recess portions 82 are partially removed in the film thickness direction to reduce the film thickness thereof (FIG. 9G). Accordingly, the recess portions 82 are formed in the first insulating film 35 (the planarizing film 38 and the protection film 34). The removing process is performed as follows. The planarizing film 38 is patterned by etching with using the resist films having different thicknesses as a mask in different portions. In a configuration including the photosensitive planarizng film 38, the planarizing film 38 is pattered by exposing with using half-tone masks including light blocking sections having different light transmittance in different portions. The protection film 34 is etched with using the patterned planarizing film 38 as a mask (FIG. 9H). Accordingly, the through portions 81 are formed in the first insulating film 35 (the planarizing film 38 and the protection film 34). As illustrated in FIG. 9H, the through portions 81 overlap and are communicated with grooves that are formed with patterning the gate insulating film 32 in the producing process in FIG. 9C.

In the same way, the cross-sectional portion illustrated in FIG. 6B is formed with the producing process illustrated in FIGS. 10A to 10H. FIGS. 10A to 10H correspond to the producing processes of FIGS. 9A to 9H, respectively, and particularly illustrate a method of forming the through portions 81. In the same way, the cross-sectional portion illustrated in FIG. 6C is formed with the producing process illustrated in FIGS. 11A to 11H. FIGS. 11A to 11H correspond to the producing processes of FIGS. 10A to 10H, respectively, and particularly illustrate a method of forming the recess portions 82.

As described above, the array substrate 30 in this embodiment includes the glass substrate GS, the source metal film MF2 disposed in a layer upper than the glass substrate GS, the first insulating film 35 disposed on the source metal film MF2, and the alignment film PI disposed on the first insulating film 35. The first insulating film 35 includes the groove portion 80 including the through portions 81 and the recess portions 82. The through portions 81 extend through the first insulating film 35 and the recess portions 82 are recessed in the first insulating film 35 not to extend therethrough. The through portions 81 do not overlap the source metal film MF2 and the recess portions 82 overlap at least the source metal film MF2.

According to such a configuration, the groove portion 80 included in the first insulating film 35 stores droplets of the material for the alignment film PI that is to be disposed on the surface of the first insulating film 35 and restricts the spread of the material for the alignment film PI with wetting. Since the groove portion 80 includes the through portions 81 that extend through the first insulating film 35, the groove portion 80 has a greater depth in the through portions 81 and the capacity for storing (a restricting amount of) the material for the alignment film PI is increased. As a result, the spread of the material for the alignment film PI is surely restricted. On the other hand, the first insulating film 35 protects the source metal film MF2 from moisture. If the through portion 81 extends to the source metal film MF2 and the source metal film MF2 is contacted with the alignment film PI, the source metal film MF2 absorbs moisture contained in the material for the alignment film PI and the metal characteristics of the source metal film MF are deteriorated. The groove portion 80 according to the present embodiment is formed such that the through portions 81 do not overlap the source metal film MF2 and the recess portions 82 overlap the source metal film MF2. According to such a configuration, the source metal film MF2 is covered with the first insulating film 35 included in the recess portion 82 and the source metal film MF2 is less likely to be deteriorated. Therefore, in the array substrate 30 according to the present embodiment, the source metal film MF2 is less likely to be deteriorated by the recess portions 82 of the groove portion 80 and the spread of the material for the alignment film PI is restricted by the through portions 81 of the groove portion 80 more surely.

In the above embodiment, a portion of the planarizing film 38 in the film thickness direction is removed in the recess portion 82; however, the portion of the planarizing film 38 ranging over an entire thickness thereof may be removed. In the recess portion 82, the protection film is not removed and has the same thickness as that of portions other than the groove portion 80. However, a portion of the protection film 34 in the thickness direction may be removed and the film thickness thereof may be reduced as long as the source metal film MF2 is covered with the protection film 34.

### Second Embodiment

Next, a groove portion 180 according to a second embodiment will be described with reference to FIGS. 12 and 13. The groove portion 180 differs from that in the first embodiment and is formed in the first insulating film 35 and extends along the GDM column line 64 of the basic circuit 60A of the GDM section 60, as illustrated in FIG. 12. Configurations, operations, and effects of the second embodiment similar to those of the first embodiment previously described will not be described.

FIG. 12 is a plan view illustrating a portion of the basic circuit 60A including the groove portion 180. FIG. 13 is a cross-sectional view taken along line A-A in FIG. 12. As illustrated in FIGS. 12 and 13, through portions 181 do not overlap the GDM row line 63 (the source metal film MF2) and recess portions 182 overlap the GDM row line 63 (the source metal film MF2).

### Third Embodiment

A groove portion 280 according to a third embodiment will be described with reference to FIG. 14 and FIG. 15. The groove portion 280 differs from those in the first embodiment and the second embodiment and is formed in a portion of the first insulating film 35 that does not overlap the TFT 61 and the GDM column line 64 of the basic circuit 60A of the GDM section 60. Configurations, operations, and effects of the third embodiment similar to those of the first and second embodiments previously described will not be described.

FIG. 14 is a plan view illustrating a portion of the basic circuit 60A including the groove portion 280. FIG. 15 is a cross-sectional view taken along line A-A in FIG. 14. As illustrated in FIGS. 14 and 15, through portions 281 do not overlap the GDM row line 63 (the source metal film MF2) and recess portions 282 overlap the GDM row line 63 (the source metal film MF2). The through portions 281 are not necessarily formed in an entire area of the portion of the first insulating film 35 that does not overlap the GDM row line 63 (the source metal film MF2). In this embodiment, the through portion 281 is not formed between the two GDM row lines 63 that are included in the recess portion 282 because a space between the two GDM row lines 63 is small. Thus, the forming area of the through portion 281 can be set freely in a portion that does not overlap the source metal film MF2 as appropriate.

### Fourth Embodiment

A groove portion 380 according to a fourth embodiment will be described with reference to FIG. 16 and FIG. 17. The groove portion 380 differs from those in the first embodiment and the third embodiment and is formed to overlap the capacitor 62 of the basic circuit 60A of the GDM section 60, as illustrated in FIG. 16. Configurations, operations, and effects of the fourth embodiment similar to those of the first to third embodiments previously described will not be described.

FIG. 16 is a plan view illustrating a portion of the basic circuit 60A including the groove portion 380. FIG. 17 is a cross-sectional view taken along line A-A in FIG. 16. The capacitor 62 includes a first electrode 62A that is a section of the gate metal film MF1 and a second electrode 62B that is a section of the source metal film MF2. The first electrode 62A and the second electrode 62B are opposite each other via the gate insulating film 32 to create a capacitance. A through portion 381 is formed not to overlap the GDM row line (the source metal film MF2) and the capacitor 62 including the second electrode 62B (the source metal film MF2). A recess portion 382 is formed to overlap the GDM row line 63 (the source metal film MF2) and the capacitor 62 including the second electrode 62B (the source metal film MF2).

### Fifth Embodiment

A groove portion 480 according to a fifth embodiment will be described with reference to FIG. 18 and FIG. 19. As illustrated in FIG. 18, the groove portion 480 is formed to overlap a contact portion 68A of the basic circuit of the GDM section 60. Configurations, operations, and effects of the fifth embodiment similar to those of the first to fourth embodiments previously described will not be described.

FIG. 18 is a plan view illustrating a portion of the basic circuit 60A including the groove portion 480. FIG. 19 is a cross-sectional view taken along line A-A in FIG. 18. The gate insulating film 32 includes a contact hole 68 therethrough to connect a lower electrode 65 that is connected to the gate electrode 61G of the TFT 61 and is a section of the gate metal film MF1 and an upper electrode 66 that is connected to the GDM row line 63 and is a section of the source metal film MF2. The contact portion 68A within the contact hole 68 is a section of the source metal film MF2. The through portion 481 is formed not to overlap the GDM row line 63 (the source metal film MF2), the upper electrode 66 (the source metal film MF2), and the contact portion 68A (the source metal film MF2). The recess portion 482 is formed to overlap the GDM row line 63 (the source metal film MF2), the upper electrode 66 (the source metal film MF2), and the contact portion 68A (the source metal film MF2).

### Sixth Embodiment

A groove portion 580 according to a sixth embodiment will be described with reference to FIGS. 20 to 21B. As illustrated in FIG. 20, the groove portion 580 is formed in the first insulating film 35 in the GDM line section 70. Configurations, operations, and effects of the sixth embodiment similar to those of the first to fifth embodiments previously described will not be described.

FIG. 20 is a plan view illustrating the position of the groove portion 580 in the GDM line section 70. FIG. 21A is a cross-sectional view taken along line A-A in FIG. 20 and FIG. 21B is a cross-sectional view taken along line B-B in FIG. 20. The groove portion 580 includes an outer groove 580B and an inner groove 580A. The outer groove 580B is formed on a trunk line 71B and the inner groove 580A is formed between the trunk line 71B and a trunk line 71C. As illustrated in FIG. 21A, the trunk line 71 (the gate metal film MF1) and a branch line 72 (the source metal film MF2) are connected to each other via the inner portion of a contact hole 73 (a contact portion 73A) that is a section of the source metal film MF2. The through portions 581 of the groove portion 580 is formed not to overlap the branch line 72 (the source metal film MF2) and the contact portion 73A (the source metal film MF2). A recess portion 582 is formed to overlap the branch line 72 (the source metal film MF2) and the contact portion 73A (the source metal film MF2).

### Seventh Embodiment

The groove portion 80 according to a seventh embodiment will be described with reference to FIGS. 22A to 22C. In this embodiment, a first insulating film 135 does not include the planarizing film 38 and is a single layer film of a protection film 134. The groove portion 80 is formed in the protection film 134. Configurations, operations, and effects of the seventh embodiment similar to those of the first to sixth embodiments previously described will not be described.

FIGS. 22A to 22C are cross-sectional views of the groove portion according to the seventh embodiment taken along line A-A, line B-B, and line C-C in FIG. 5, respectively. The first insulating film 135 does not include the planarizing film 38 and is a single layer film of the protection film 134. The portion of the first insulating film 135 (the protection film 134) corresponding to the through portion 81 is removed entirely in the film thickness direction, as illustrated in FIGS. 22A and 22B. On the other hand, as illustrated in FIGS. 22A and 22C, the portion of the protection film 134 corresponding to the recess portion 82 is removed partially in the film thickness direction. Accordingly, the recess portion is recessed by a reduced amount in thickness of the protection film 134. The groove portion 80 is formed such that the through portion 81 does not overlap the source metal film MF2 and the recess portion 82 overlaps the source metal film MF2. In the present embodiment, deterioration of the source metal film MF2 is prevented from occurring by the recess portions 82 and the spread of the material for the alignment film PI is restricted by the through portion 81.

The groove portion 80 according to the present embodiment is formed with a producing method as will be described below. First, the processes are performed until the protection film 134 is formed according to the producing processes same as those of the first embodiment described in FIGS. 9A to 9E. Next, a portion of the protection film 134 corresponding to the through portion 81 ranging over entire thickness thereof is removed and a portion of the protection film 134 corresponding to the recess portion 82 is removed partially in the thickness direction thereof. Thus, the through portion 81 and the recess portion 82 are formed in the protection film 134. The protection film 134 is patterned by etching with using the resist films having different thicknesses as a mask in different portions.

<First Modification>

A groove portion 580 according to a first modification will be described with reference to FIGS. 23 to 24H. In the first modification, the configuration of the contact portion 73A in the sixth embodiment is altered and the semiconductor film 33 is disposed on a portion of the gate insulating film 32 overlapping the gate metal film MF1. Configurations, operations, and effects of the first modification similar to those of the first to seventh embodiments previously described will not be described.

The position of the groove portion 580 according to the first modification is same as that of the GDM line section 70 in the sixth embodiment illustrated in FIG. 20. FIG. 23 is a cross-sectional view of the groove portion according to the first modification taken along line A-A in FIG. 20. A contact hole 173 in the first modification differs from the contact hole 73 in the sixth embodiment and includes a contact portion 173A therein and is a section of a transparent electrode film such as indium tin oxide (ITO). As illustrated in FIG. 23, the contact portion 173A extends from an upper layer side of the branch line 72 (the source metal film MF2) through the insulating film 34 and the gate insulating film 32 to connect the branch line 72 and the trunk line 71 (the gate metal film MF1). The semiconductor film 33 is disposed as an etching stop layer on a portion of the gate insulating film 32 corresponding to the through portion 581 and overlapping the trunk line 71.

A method of producing the groove portion 580 having the above configuration will be described with reference to FIGS. 24A to 24H. An array substrate in the first modification is produced with using a smaller number of masks except for the patterning process of patterning the gate insulating film 32 in the first embodiment. Specifically, after the trunk line 71 (the gate metal film MF1) is patterned (FIG. 24A), the gate insulating film 32 and the semiconductor film 33 are formed in this order and the semiconductor film 33 is patterned (FIG. 24B). Next, the pattering process of patterning the gate insulating film 32 is not performed and the source metal film MF2 is formed and patterned to form the branch lines 72 (FIG. 24C). The protection film 34 and the planarizing film 38 are sequentially formed on the branch lines 72 (FIG. 24D, FIG. 24E). The portions of the planarizing film corresponding to the through portions 581 are removed entirely in the thickness direction thereof. The portions of the planarizing film 38 corresponding to the recess portions 582 are removed partially in the thickness direction thereof (FIG. 24F). Thus, the recess portions 582 are formed. The protection film 34 and the gate insulation film 32 are etched with using the patterned planarizing film 38 as a mask (FIG. 24G). Accordingly, the through portions 581 are formed and the contact hole 173 is formed. The transparent electrode film is disposed in the contact hole 173 (the contact portion 13A) and pattered (FIG. 24H). The transparent electrode film is also used in producing the array substrate 30 in the display area AA. Therefore, the number of masks is not increased by the producing process illustrated in FIG. 24H.

As described above, the producing method in the first modification does not include the patterning process of patterning the gate insulating film 32 and the number of required masks is reduced and efficiency of the producing method is improved compared to the producing method in the first embodiment. Further, since the patterning process is not included, the semiconductor film 33 is disposed as the etching stopper layer on a portion of the gate insulating film 32 overlapping the trunk line 71 such that the portion of the gate insulating film 32 covering the trunk line 71 is not removed in the etching in FIG. 24G.

<Second Modification>

The groove portion 180 according to a second modification will be described with reference to FIG. 25. The second modification includes the semiconductor film 33 on the portion of the gate insulating film 32 overlapping the gate metal film MF1. The groove portion 180 in the second modification extends along the GDM column line 64 of the second embodiment illustrated in FIG. 12. Configurations, operations, and effects of the second modification similar to those of the first to seventh embodiments and the first modification previously described will not be described.

FIG. 25 is a cross-sectional view of the groove portion according to the second modification taken along line A-A in FIG. 12. An array substrate in the second modification is produced in the same producing method as that in the first modification. The number of required masks is reduced and efficiency of the producing method is improved compared to the producing method in the second embodiment. Since the patterning process of patterning the gate insulating film 32 is not included, the semiconductor film 33 is disposed as the etching stopper layer on a portion of the gate insulating film 32 overlapping the through portion 181 and the GDM column line (the gate metal film MF1) because of the same reasons as those in the first modification.

<Third Modification>

The groove portion 80 according to a third modification will be described with reference to FIG. 26. The third modification includes the semiconductor film 33 on the portion of the gate insulating film 32 overlapping the gate metal film MF1. The position of the groove portion 80 in the third modification is same as that of the extended line section in the first embodiment illustrated in FIG. 7. Configurations, operations, and effects of the third modification similar to those of the first to seventh embodiments, the first modification, and the second modification previously described will not be described.

FIG. 26 is a cross-sectional view of the groove portion according to the third modification taken along line A-A in FIG. 7. An array substrate in the third modification is produced in the same producing method as that in the first modification. The number of required masks is reduced and efficiency of the producing method is improved compared to the producing method in the first embodiment. Since the patterning process of patterning the gate insulating film 32 is not included, the semiconductor film 33 is disposed as the etching stopper layer on a portion of the gate insulating film 32 overlapping the through portion 81 and the first extended line (the gate metal film MF1) because of the same reasons as those in the first modification.

<Fourth Modification>

A groove portion 480 according to a fourth modification will be described with reference to FIGS. 27 and 28. The fourth modification includes a contact portion having a configuration altered from that in the fifth embodiment. Configurations, operations, and effects of the fourth modification similar to those of the first to seventh embodiments and the first to third modifications previously described will not be described.

FIG. 27 is a plan view of the groove portion according to the fourth modification and FIG. 28 is a cross-sectional view taken along line A-A in FIG. 27. An array substrate in the fourth modification is produced with the same producing method as that in the first modification. The number of required masks is reduced and efficiency of the producing method is improved compared to the producing method in the fifth embodiment. A contact hole 168 differs from the contact hole 68 in the fifth embodiment and is filled with a transparent electrode film such as ITO as a contact portion 168A therein. The contact portion 168A extends from an upper side of the upper electrode 66 (the source metal film MF2) through the insulating film 34 and the gate insulating film 32 and connects the upper electrode 66 and the lower electrode 65 (the gate metal film MF1).

### Other Embodiments

The present technology is not limited to the embodiments described above and illustrated by the drawings. For example, the following embodiments will be included in the technical scope.

(1) In the above embodiments, the groove portion includes two grooves each of which has a rectangular shape; however, the number of the grooves may be any number as long as at least one groove is included. In a configuration including multiple grooves, the grooves may have different shapes.

(2) In the above embodiments, the groove included in the groove portion has a constant width and different depths (the through portions and the recess portions); however, the through portion and the recess portion may have different widths. In the above embodiments, the recess portions have a same depth; however, the recess portions may have different depths at different positions as long as they cover the source metal film.

(3) In the above embodiments, the long-side section of the groove portion that is on an opposite side from the driver (a portion of the array substrate where various lines and the components of the circuit are not disposed) includes only the through portions but may include only the recess portions or may include the through portions and the recess portions.

(4) In the above embodiments, the gate lines, the gate electrodes, the source lines, the source electrodes, the drain electrodes, and thin film patterns of various kinds of insulating films are described as examples and may be altered as appropriate. For example, the bottom-gate type transistors are used as the TFTs in the above embodiments; however, top-gate type transistors or double-gate type transistors may be used. In the above embodiments, the gate lines are connected to the GDM sections that are disposed on the right and left sides, respectively. However, the gate lines may be connected to only one of the GDM sections alternately one by one or the GDM section may be disposed on only one of the right and left sides.

(5) In the above embodiments, the trunk lines of the GDM lines are sections of the gate metal film and the branch lines are sections of the source metal film. However, the trunk lines may be sections of the source metal film and the branch lines may be sections of the gate metal film.

(6) In each of the above embodiments, the liquid crystal panel has a rectangular planar shape; however, a liquid crystal panel having a planar shape of a square, a circle, or an oval may be used.

1. An array substrate comprising:
an insulating substrate;
a source metal film disposed in a layer upper than the insulating substrate;
a first insulating film disposed on the source metal film; and
an alignment film disposed on the first insulating film, wherein
the first insulating film includes a groove portion including a through portion and a recess portion, the through portion extends through the first insulating film and the recess portion is recessed in the first insulating film so as not to extend through the first insulating film,
the through portion does not overlap the source metal film, and
the recess portion overlaps at least the source metal film.

2. The array substrate according to claim 1, wherein
the first insulating film includes a protection film and a planarizing film that is disposed on the protection film, and
a thickness of the planarizing film in the recess portion is smaller than a thickness of the planarizing film in portions other than the groove portion.

3. The array substrate according to claim 1, wherein
the first insulating film includes a protection film, and
a thickness of the protection film in the recess portion is smaller than a thickness of the protection film in portions other than the groove portion.

4. The array substrate according to claim 1, further comprising:
a gate metal film disposed in a layer lower than the source metal film; and
a gate insulating film disposed between the gate metal film and the source metal film, wherein
the through portion extends through a portion of the gate insulating film that does not overlap the gate metal film.

5. The array substrate according to claim 1, further comprising:
a gate metal film disposed in a layer lower than the source metal film; and
a gate insulating film disposed between the gate metal film and the source metal film, wherein
a semiconductor film is disposed on a portion of the gate insulating film that is in the through portion and overlaps the gate metal film.

6. The array substrate according to claim 4, further comprising a gate driving circuit included in a monolithic manner and configured to supply a driving signal to a gate line that is a section of the gate metal film, wherein
the groove portion is included in the first insulating film of the gate driving circuit.

7. The array substrate according to claim 6, wherein
the gate driving circuit includes a thin film transistor including a gate electrode that is a section of the gate metal film and a source electrode that is a section of the source metal film, and
the groove portion overlaps at least the thin film transistor.

8. The array substrate according to claim 6, wherein
the gate driving circuit includes a first electrode that is a section of the gate metal film and a second electrode that is a section of the source metal film, and
the groove portion overlaps at least the capacitor.

9. The array substrate according to claim 4, further comprising a gate driving circuit line section included in a monolithic manner, the gate driving circuit line section connecting a gate driving circuit configured to supply a driving signal to a gate line that is a section of the gate metal film and terminals for connection to an external device, wherein
the groove portion is included at least in the first insulating film of the gate driving circuit line section.

10. The array substrate according to claim 9, wherein
the gate driving circuit line section includes a trunk line connected to the terminals and a branch line connecting the trunk line and the gate driving circuit, and
the groove portion extends along at least the trunk line.

11. The array substrate according to claim 4, further comprising an extended line section included in a monolithic way, the extended line section connecting a source line that is a section of the source metal film and a source driving circuit that supplies a driving signal to the source line, wherein
the groove portion is included at least in the first insulating film of the extended line section.

12. The array substrate according to claim 11, wherein the extended line section includes first extended lines that are sections of the gate metal film and second extended lines that are sections of the source metal film and the first extended lines and the second extended lines are arranged alternately in a plan view.

13. The array substrate according to claim 1, wherein
the array substrate is defined into a display area and a non-display area surrounding the display area, and
the groove portion is included in the non-display area so as to surround an entire periphery of the display area.

14. The array substrate according to claim 13, wherein the groove portion includes grooves that are arranged in a concentric manner in the non-display area.

15. A display panel comprising:
the array substrate according to claim 13;
an opposed substrate opposed to the array substrate so as to have an inner space therebetween; and
a sealant disposed between the array substrate and the opposed substrate to surround and seal the inner space, wherein
the groove portion is disposed in the non-display area and closer to the display area than the sealant is.

16. A display panel comprising:
the array substrate according to claim 1; and
an opposed substrate opposed to the array substrate so as to have an inner space therebetween.

17. The display panel according to claim 16, further comprising a sealant disposed between the array substrate and the opposed substrate to surround and seal the inner space, wherein
liquid crystals are sealed in the inner space.

18. A display device comprising the display panel according to claim 15.
